(19) United States
(12) Patent Application Publication
(10) Pub. No.: US 2025/0054362 A1
(43) Pub. Date: Feb. 13, 2025

(54) GAME TOKEN MANAGEMENT SYSTEM

(71) Applicant: ANGEL GROUP CO., LTD., Shiga (JP)

(72) Inventor: Yasushi Shigeta, Shiga (JP)

(21) Appl. No.: 18/927,165

(22) Filed: Oct. 25, 2024

Related U.S. Application Data
(63) Continuation of application No. 16/322,693, filed on Feb. 1, 2019.

(30) Foreign Application Priority Data
Aug. 2, 2016 (WO) PCT/JP2016/072673

(51) Int. Cl. G07F 17/32; A44C 21/00; A63F 1/06; A63F 1/18; A63F 3/00; A63F 9/24; B32B 27/08; B32B 37/18; G01G 19/52; G01G 19/62; G06F 1/18; G06K 7/10; G06K 19/04; G06K 19/077; G06Q 20/00; G06Q 20/20; G06Q 50/10; G07D 5/00; G07D 5/04; G07D 5/08; G07G 1/00; H05K 7/14

(52) U.S. Cl. CPC G07F 17/3241; A44C 21/00; A63F 1/06; A63F 1/067; A63F 1/18; A63F 3/00; A63F 3/00157; A63F 9/24; B32B 27/08; B32B 37/182; G01G 19/52; G01G 19/62; G06F 1/187; G06K 7/10366; G06K 7/10415; G06K 19/047; G06K 19/077; G06Q 20/00; G06Q 20/208; G06Q 50/10; G07D 5/00; G07D 5/04; G07D 5/08; G07F 17/32; G07F 17/3206; G07F 17/322; G07F 17/3223; G07F 17/3232; G07F 17/3234; G07F 17/3237; G07F 17/3248; G07F 17/3251; G07G 1/00; G07G 1/0072; H05K 7/1401; H05K 7/1489; A63F 2009/2435; A63F 2009/2489; A63F 2250/58; G06T 2207/20084; G07F 17/3293

(57) ABSTRACT

A game token management system includes: a game token tray for storing game tokens of a dealer; a card distribution device that determines a result of a game; a management control device that determines a target and an amount bet by a player and an amount of the game tokens held in the game token tray and determines whether a change of the game tokens in the game token tray after an end of the game is accurate or inaccurate; and an indicator lamp that is turned on or off according to determination of the management control device.

### CROSS-REFERENCE TO RELATED APPLICATION

This application is a continuation of U.S. patent application Ser. No. 16/322,693 filed Feb. 1, 2019, which is a national phase application under 35 USC § 371 of International App. PCT/JP2017/027954 filed Aug. 1, 2017, which claims the benefit of priority to International App. PCT/JP2016/072673 filed Aug. 2, 2016. The disclosure of each application is hereby incorporated by reference.

### TECHNICAL FIELD

The present invention relates to a management system of game tokens (gaming chips) in a game house.

### BACKGROUND ART

In game houses such as casinos, there are various attempts for preventing fraud. A game house includes monitoring cameras used for monitoring fraud and prevents fraud by determining fraud of a game, fraud according to collection or repayment of game tokens that is different from the result of win/loose, and the like based on an image acquired from the monitoring camera.

Meanwhile, in order to perceive the number or a total amount of bet game tokens, it has been proposed to perceive the amount of game tokens by attaching a radio IC (RFID) tag to each game token.

In a card game monitoring system disclosed in WO 2015/107902 A, it is determined whether or not game tokens placed on a game table are collected or re-payed according to a result of win/loose by performing an image analysis of the movement of game tokens, whereby fraud is monitored.

### SUMMARY OF INVENTION

An object of the invention is to provide a novel management system capable of detecting a mistake or fraudulent act when paying for game tokens in a game of a game house.

According to an aspect of the invention, there is provided a game token management system including: a game token having an individually identifiable unique identification (ID); a gaming table for playing a game using the game token; a winning/losing determination device configured to determine and display a game winning/losing result on the gaming table; a game token tray configured to hold the game token used by a dealer on the gaming table; a dealer chip determination device configured to specify a type and the number of the game tokens held in the game token tray using the unique ID; a measurement device configured to measure a position, a type, and the number of the game tokens on the gaming table using a camera; and a management control device configured to recognize a position, a type, and the number of the game tokens on the gaming table and having a balance count function of a casino side on the gaming table using the winning/losing result obtained from the winning/losing determination device, in which the management control device recognizes and calculates the amount of game tokens to be collected by the casino side on the gaming table in the game on the basis of information obtained from the measurement device, the dealer chip determination device, and the winning/losing determination device, and compares the amount to be collected and an collection increase amount of the game tokens collected by the dealer and placed on the game token tray, the collection increase amount of the game tokens being obtained from the dealer chip determination device, and the management control device has a function of comparing a payout amount of the game tokens to be paid out by the casino side and a decrease amount of the game tokens extracted by the dealer from the game token tray and paid out and then placed in the game token tray and displaying a match or a mismatch on a display device according to a result of comparison between the amount to be collected and the collection amount and a result of comparison between the amount of the game tokens to be paid out and the payout amount.

The management control device may have a function of recognizing and calculating the amount of the game tokens to be collected and the amount of the game tokens to be paid out on the gaming table for each player position of the gaming table, comparing the collection amount or the payout amount for each player position of the gaming table and an increase or decrease amount of the game tokens placed in the game token tray, and displaying a match or a mismatch of a comparison result using the display device for each player position of the gaming table.

The display device may have a display function for each bet target of a banker or a player.

The display device may have a display function for each bet target of a tie or a pair.

The game token tray may have a collecting portion for temporarily storing game tokens collected by a dealer, and the management control device may have a function of comparing the amount to be collected and an increase amount by collection of the game tokens collected by the dealer and then placed in the collecting portion and displaying a match or a mismatch on the display device according to a comparison result.

The measurement device may further have a function of measuring a type and the number of the game tokens held in the game token tray using a camera, and the management control device may have a function of comparing the number of the game tokens whose IDs are specified by the dealer chip determination device and the number of the game tokens held in the game token tray, measured using the measurement device, and displaying a match or a mismatch on the display device according to a comparison result.

According to another aspect of the invention, there is provided a game token management system including: a game token having an individually identifiable unique identification (ID); a gaming table for playing a game using the game token; a winning/losing determination device configured to determine and display a game winning/losing result on the gaming table; a game token tray configured to hold the game token used by the dealer on the gaming table; a dealer chip determination device configured to specify a type and the number of the game tokens held in the game token tray using the unique ID; a measurement device configured to measure a position, a type, and the number of the game tokens on the gaming table using a camera; and a management control device configured to recognize a position, a type, and the number of the game tokens on the gaming table and having a balance count function of a casino side on the gaming table using the winning/losing result obtained from the winning/losing determination device, in which the management control device has a function of recognizing and calculating an amount to be collected by a casino side and an amount to be paid out by the casino side in the game on the basis of information obtained from the winning/losing determination device, the dealer chip determination device, and the measurement device, comparing the amount to be collected or paid out by the casino side and an increase or decrease amount of the game tokens placed in the game token tray, obtained from the dealer chip determination device after settlement of the game performed by a dealer, and displaying, on the display device, a match or a mismatch of each comparison result at the time of collection or payout of the game tokens.

The management control device may have a function of recognizing the amount of the game tokens to be collected or to be paid out on the gaming table for each player position of the gaming table, and displaying a match or a mismatch of the comparison result using the display device for each player position of the gaming table after settlement of the corresponding game performed by the dealer for each player position of the gaming table.

The display device may have a display function for each bet target of a banker or a player.

The display device may have a display function for each bet target of a tie or a pair.

The management control device may have a function of recognizing and calculating the amount of the game tokens to be collected by the casino side and the amount of the game token to be paid out by the casino side on the gaming table for each player position of the gaming table, and displaying, on the display device, a position where the game tokens are to be collected or paid out for each player position of the gaming table.

The game token tray may have a collecting portion for temporarily storing game tokens collected by a dealer, and the management control device may have a function of comparing the amount to be collected and an increase amount by collection of the game tokens collected by the dealer and then placed in the game token tray, and displaying a match or a mismatch on the display device according to a comparison result.

The measurement device may further have a function of measuring a type and the number of the game tokens held in the game token tray using a camera, and the management control device may have a function of comparing the number of the game tokens whose IDs are specified by the dealer chip determination device and the number of the game tokens held in the game token tray, measured using the measurement device, and displaying a match or a mismatch on the display device according to a comparison result.

The management control device may have a function of measuring the game tokens to be collected by a dealer from the gaming table on the basis of a measurement result obtained from the measurement device and verifying that the game token does not exist on the gaming table as the dealer collects the game tokens from the gaming table.

The management control device may have a function of measuring the game tokens to be collected by a dealer from the gaming table on the basis of a measurement result obtained from the measurement device and verifying that the game token does not exist on the gaming table as the dealer collects the game tokens from the gaming table in accordance with a predetermined rule.

The management control device may further have a function of comparing the increase amount by collection of the game tokens collected by the dealer and placed in the game token tray, obtained from the dealer chip determination device, and a verification result for a fact that the game token does not exist on the gaming table as the dealer collects the game tokens from the gaming table and verifying the comparison result.

The management control device may have a function of specifying a game participant on the gaming table and associating a player position on the gaming table at the time of participating to the game with the game participant.

According to further another aspect of the invention, there is provided a game token management system including: a game token tray for storing game tokens of a dealer; and a lamp for indicating whether a change of the game tokens in the game token tray after an end of a game is accurate and/or inaccurate.

The management system described above may further include: a bet determination device configured to determine a target and an amount bet by a player; a game result determination device configured to determine a result of the game; and a dealer chip determination device configured to determine the amount of the game tokens held in the game token tray, in which the lamp may be turned on or off according to determination results of the bet determination device, the game result determination device, and the dealer chip determination device.

### BRIEF DESCRIPTION OF DRAWINGS

FIG. 1 is a diagram illustrating an overview of the whole fraud detecting system in a game house including a plurality of gaming tables according to a first embodiment of the present invention.

FIG. 2A is a perspective view of game tokens illustrating an example of another overlapping state of game tokens perceived according to the first embodiment of the present invention.

FIG. 2B is a perspective view of game tokens illustrating an example of another overlapping state of game tokens perceived according to the first embodiment of the present invention.

FIG. 3 is an enlarged diagram of a mark illustrating contamination of a card perceived according to the first embodiment of the present invention.

FIG. 4A is a plan view illustrating the front side of a marker.

FIG. 4B is a plan view illustrating the back side of a marker.

FIG. 5 is an explanatory diagram simplifying a video of the state of exchange of bills and game tokens perceived according to the first embodiment of the present invention.

FIG. 6 is a plan view illustrating an overview of the whole management system for table games in a game house according to a second embodiment of the present invention.

FIG. 7 is a perspective view of conventional game tokens.

FIG. 8 is a side-face cross-sectional view of game token according to the second embodiment of the present invention.

FIG. 9A is a side view of game token according to the second embodiment of the present invention.

FIG. 9B is a side view of game token according to the second embodiment of the present invention.

FIG. 10A is a diagram illustrating another example of game token according to the second embodiment of the present invention.

FIG. 10B is a diagram illustrating another example of game token according to the second embodiment of the present invention.

FIG. 11 is a perspective view of a state in which game tokens are piled according to the second embodiment of the present invention.

FIG. 12 is a perspective explanatory photographic diagram illustrating a state in which different kinds of game tokens are piled.

FIG. 13A is a diagram illustrating details of a game token tray according to the first embodiment of the present invention.

FIG. 13B is a diagram illustrating another example of a game token tray according to the first embodiment of the present invention.

FIG. 14A is a diagram illustrating a relation between a game token tray having a two-stage structure and a camera device 2 and is a diagram illustrating a state in which two stages are overlapped.

FIG. 14B is a diagram illustrating a relation between a game token tray having a two-stage structure and a camera device 2 and is a diagram illustrating a state in which two stages are shifted from each other.

FIG. 15 is a diagram illustrating an inspection device inspecting game tokens according to the second embodiment.

FIG. 16 is a diagram illustrating an overview of the whole game tokens management system according to a third embodiment of the present invention.

FIG. 17 is a side view of game token according to the third embodiment of the present invention.

FIG. 18 is a diagram illustrating game token configuring a code (four kinds) using upper and lower marks C as a pair.

FIG. 19 is a diagram illustrating game token in which side IDs are printed using ink (ink absorbing infrared rays) that is invisible for visible light.

FIG. 20A is a plan view of a main part of a game token tray illustrating a state in which game tokens according to the third embodiment are held in a game token tray of a casino table.

FIG. 20B is a perspective view of a state in which game tokens are piled.

FIG. 21 is a diagram illustrating another example of game token according to the third embodiment.

FIG. 22 is a diagram illustrating another example of an inspection device inspecting game tokens.

FIG. 23 is a diagram illustrating another example of an inspection device inspecting game tokens.

FIG. 24 is a diagram illustrating another example of an inspection device inspecting game tokens.

FIG. 25 is a plan view illustrating a gaming table according to a fourth embodiment.

FIG. 26 is a plan view illustrating a game token tray according to the fourth embodiment.

FIG. 27 is a schematic diagram illustrating a game token management system according to the fourth embodiment.

FIG. 28 is a plan view illustrating a game token tray according to a modification of the fourth embodiment.

FIG. 29 is a plan view illustrating a game token tray according to a modification of the fourth embodiment.

FIG. 30 is a plan view illustrating a game token tray according to a modification of the fourth embodiment.

### DESCRIPTION OF EMBODIMENTS

In game houses such as casinos, while game tokens are piled to have a high volume and is placed on a game table, there is a problem in that a total amount cannot be correctly read by a reading device for IC tags disposed under the game table, and, when the sensitivity of the reading device is increased, game tokens placed at a different position (winning/losing depends on the position) is added, and there is a problem in that a total amount of game tokens at each position cannot be perceived. In addition, in imaging using a camera, there is a problem in that a blind area is generated according to the viewing angle of the camera, or game tokens enter a shadow due to overlapping, and thus, there is a problem in that a total amount of game tokens cannot be perceived.

In addition, according to player's squeeze (a behavior for seeing a card little by little by bending a card facing the back side while enjoying the rank of the card or the like) of a card, which is frequently performed in a Baccarat game, or the like, the card is bent, and there is a problem in that the rank and the suit of the card cannot be determined through an analysis of an image acquired from a camera.

Furthermore, fraud on a game table has been advanced, and there is a new problem in that fraud using an advanced betting method or the like that cannot be found in simple detection of a large winning amount on a game table or the like cannot be found by using a camera or tracking a winning amount. In addition, the prevention of fraud according to a conspiracy of a dealer and a player is not sufficient according to the conventional technology.

In order to solve the various problems described above, a fraud detecting system according to a first embodiment in a game house including a plurality of game tables is a fraud detecting system in a game house including a plurality of game tables and includes: a game recording device that records a state of progress of a game performed on each of the game table as a video including a dealer and a player through a camera; an image analyzing device that performs an image analysis of the recorded video of the state of progress of the game; a card distributing device that determines and displays a result of winning/losing of each game in the game table; and a control device that detects fraud performed in the game table by using a result of the image analysis performed by the image analyzing device and the result of winning/losing determined by the card distributing device.

In addition, in the fraud detecting system, the card distributing device has a structure capable of reading the rank of each distributed card, and the control device has a structure capable of determining match/mismatch by combining information of a rank acquired by the image analyzing device from a video of each card distributed in the game table and information of a rank of a card read by the card distributing device.

In addition, in the fraud detecting system, the image analyzing device or the control device has an artificial intelligence-utilizing or deep-learning structure capable of acquiring information of a rank of a card from a card that is distributed in the game table and is bent by the player or is contaminated.

Furthermore, in the fraud detecting system, the control device acquires the position, the kind, and the quantity of game tokens that are bet by each player through the image analyzing device and determines whether or not collection of losing game tokens that are bet by each player and repayment for the winning game tokens are appropriately performed according to the result of winning/losing of the game by analyzing the video of the state of progress of the game through the image analyzing device.

In addition, in the fraud detecting system, the image analyzing device or the control device has an artificial intelligence-utilizing or deep-learning structure capable of acquiring information of the kind, the quantity, and the position of the bet game tokens also in a state in which a plurality of game tokens placed on a game table is in a state in which a part or the whole one is hidden according to a hidden area of the camera.

Furthermore, in the fraud detecting system, the control device has an artificial intelligence-utilizing or deep-learning structure capable of comparing/calculating whether or not the amount of game tokens perceived in a dealer's game token tray in the game table is increased/decreased according to the collection of losing game tokens that are bet by each player and a paid amount for winning game tokens based on a result of winning/losing of the game after the game ends and a settlement.

In addition, in the fraud detecting system, the control device has an artificial intelligence-utilizing or deep-learning structure capable of acquiring the position and the amount of game tokens that are bet at each play position of the game table and extracting an abnormal situation by comparing a winning/losing history and an acquired amount of game tokens for each player that are acquired from a result of winning/losing of each game with statistical data of past game.

Furthermore, in the fraud detecting system, the control device has an artificial intelligence-utilizing or deep-learning structure capable of extracting an abnormal situation by comparing a state in which the amount of the bet game tokens at the time of losing is smaller than the amount of the bet game tokens at the time of losing at a play position of a game table with statistical data of past games.

In addition, in the fraud detecting system, the control device has a structure capable of specifying whether the abnormal situation is extracted through the image analyzing device or an individual player at a play position at which winning of a predetermined amount of more is acquired.

Furthermore, in the fraud detecting system, the control device has a warning function for giving a notification of the presence of a specific player at another game table when the specified player leaves the seat and arrives at the another game table.

In order to solve the various problems described above, according to the present invention, a fraud detecting system in a game house including a plurality of game tables includes: a game recording device that records a state of progress of a game performed on each of the game table as a video including a dealer and a player through a camera; a card distributing device that determines a result of winning/losing of each game in the game table; an image analyzing device that performs an image analysis of the recorded video of the state of processing of the game; and a control device that can detect bills and game tokens in the game table by using a result of the image analysis performed by the image analyzing device, and the image analyzing device or the control device has an artificial intelligence-utilizing or deep-learning structure capable of detecting exchange of bills and game tokens in the game table in a situation other than in the middle of dealing cards based on information acquired from the card distributing device or the dealer, recognizing a total amount of genuine bills verified using among the bills and capable of recognizing a total amount of game tokens also in a state in which a plurality of game tokens come out onto the game table as an exchange target is in a state in which a part or the whole one is hidden due to a blind area of the camera and comparing a total amount of bills come out from the player onto the game table and a total amount of game tokens come out from the dealer with each other and determining whether or not the both quantities match.

In addition, in the fraud detecting system, the control device has an artificial intelligence-utilizing or deep-learning structure capable of comparing/calculating whether or not the amount of game tokens perceived in a dealer's game token tray in the game table is increased/decreased according to a payed amount of game tokens corresponding to exchanged bills after a settlement through exchange of bills and game tokens.

Furthermore, in the fraud detecting system, the control device has an artificial intelligence-utilizing or deep-learning structure capable of comparing/calculating match/mismatch of an input amount of bills according to a dealer's input and a total amount of bills according to a result of the image analysis performed by the image analyzing device after the settlement through exchange of bills and game tokens. In addition, the control device has an artificial intelligence-utilizing or deep-learning structure capable of comparing/calculating match/mismatch of a total input amount of bills according to a dealer's input in the game table for which the dealer is responsible and a total amount of bills according to a result of the image analysis performed by the image analyzing device.

According to a fraud detecting system according to this embodiment, also when a card is bent according to player's squeeze of the card that is frequently performed in a Baccarat game or the like, the rank and the suit of the card can be determined through an image analysis, and a total amount of game tokens disposed in the blind area or overlapping game tokens can be perceived together with the position. In addition, fraud at the time of exchange of bills and game tokens can be detected as well.

Hereinafter, an overview of the whole fraud detecting system in a game house including a plurality of game tables according to a first embodiment of the present invention will be described in more detail.

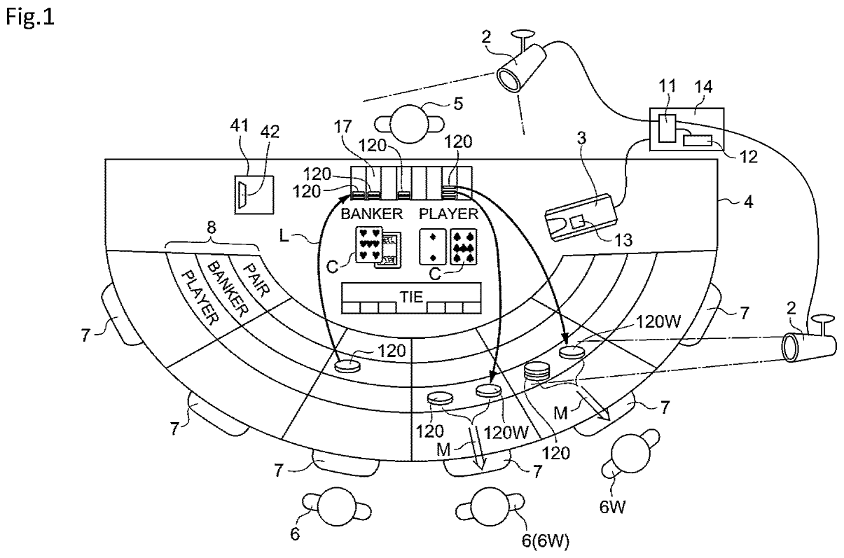

FIG. 1 is a diagram illustrating an overview of the whole system, the fraud detecting system in a game house including a plurality of game tables 4 includes: a game recording device 11 that records the state of progress of a game performed in the game table 4 as a video including players 6 and a dealer 5 through a plurality of camera devices 2; an image analyzing device 12 that performs an image analysis of the recorded video of the state of process of the game; and a card distributing device 3 that determines and displays a result of winning/losing of each game in the game table 4. The card distributing device 3 is a so-called electronic shooter that has already been used by persons skilled in the art and has rules of a game programmed in advance and has a structure capable of determining winning/losing of a game by reading information of distributed cards C. For example, in a Baccarat game, winning of the baker, winning of a player, or tie (drawn) is determined basically based on the ranks of two to three cards, and a determination result (a result of winning/losing) is displayed in a result display lamp 13.

The fraud detecting system further includes a control device 14 that compares the rank of actual cards according to a result of the image analysis performed by the image analyzing device 12 and a result of winning/losing determined by the card distributing device 3 with each other and detects fraud (mismatch between a sum of ranks of distributed cards and a result of winning/losing) performed in the game table 4. The card distributing device 3 has a structure capable of reading ranks (A, 2 to 10, J, Q, K) and suits (hearts, spades, or the like) of cards C that are manually distributed by the dealer 5, and the control device 14 has a structure capable of determining match/mismatch by collating information of a rank and suites acquired by the image analyzing device 12 (using artificial intelligence) from a video (captured by using the camera device 2) of cards distributed in the game table 4 and information of cards and suits read by the card distributing device 3 with each other. The image analyzing device 12 and the control device 14 of the fraud detecting system have a structure integrally including a computer formed as one body or by a plurality of configurations, a program, and a memory.

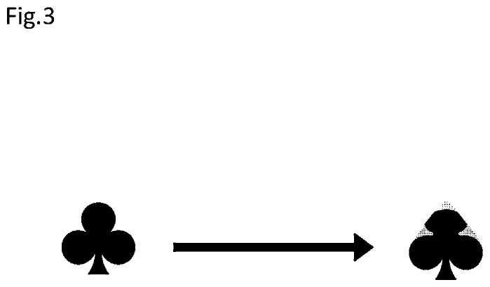

The image analyzing device 12 and the control device 14 have an artificial intelligence-utilizing or deep-learning structure capable of acquiring information of ranks of cards also for cards C that are distributed in the game table 4 and are bent or contaminated by the player 6. For a contaminated card C, as illustrated in FIG. 3, there is a situation in which it is difficult to determine clubs or spades. Also in such a case, the suite can be determined by an artificial intelligence-utilizing computer or control system, an analysis and a determination of an image using a deep learning (structure) technology. In addition, also in a case where a card is bent according to a player's squeeze of a card, which is frequently performed in a Baccarat game or the like, by using self-learning of examples of many deformations of images or the like, a suit and a rank of a card before deformation can be recognized according to an artificial intelligence-utilizing computer or control system and a deep learning (structure) technology. The artificial intelligence-utilizing computer or control system and the deep learning (structure) technology are known as a person skilled in the art and can be used, and thus, detailed description thereof will not be presented.

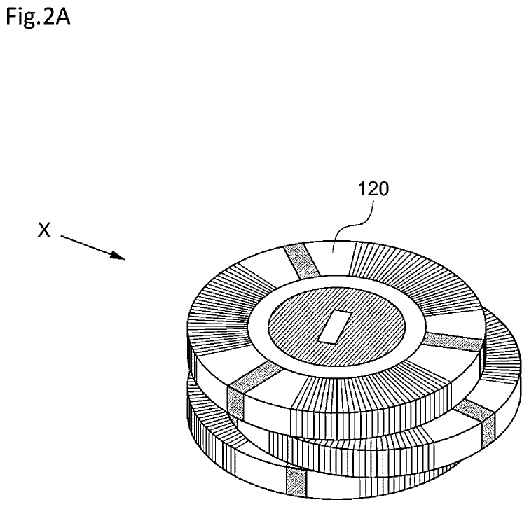

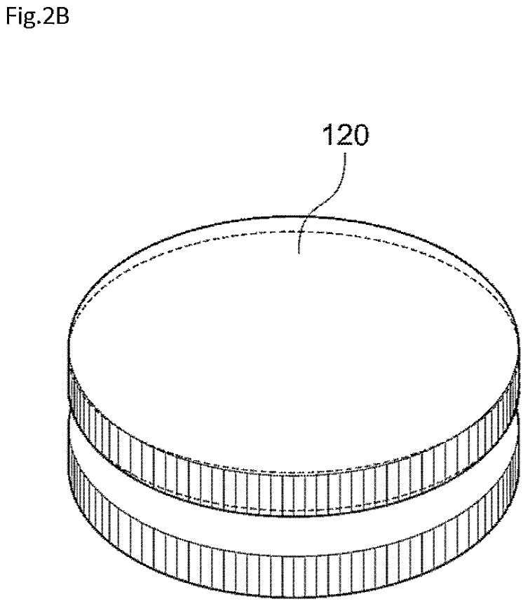

The control device 14 having an artificial intelligence-utilizing or deep learning structure can perceive a position (a player, a banker, or a pair) inside a bet area 8 on which each player 6 bets game tokens 120, the type (a value of a different amount is assigned to game tokens 120 for each color) of the bet game tokens 120 through the camera device 2 and the image analyzing device 12. Not only there is a case where the game tokens 120 are vertically arranged to be superimposed but also there is a case where the game tokens are superimposed with deviations as illustrated in FIG. 2A. In such a case, in a case where the camera device 2 is positioned in the direction of an arrow X illustrated in FIG. 2A (or the direction of the game tokens 120 are relatively in a blind area), as illustrated in FIG. 2B, it is assumed that the game token 120 is not visible (enters a blind area). According to the artificial intelligence-utilizing computer or control system or the deep-learning technology, by using a self-learning function or the like, hidden game tokens 120 due to a blind area or the like are recognized (there are case where a part of one unit of game tokens is hidden or a case where the whole game tokens are hidden), and the number of quantity and the like can be correctly perceived.

In this way, since a position (a player, a banker, or a pair) inside the bet area 8 on which the game tokens 120 are bet and the type (a value of a different amount is assigned to game tokens 120 for each color) and the quantity of the bet game tokens 120 can be perceived, the control device 14 determines whether or not collection (denoted by an arrow L) of the losing game tokens bet by each player 6 and payment (120W) for winning game tokens to a player 6W who has won are properly performed according to a result of winning/losing of a game in accordance with a result of winning/losing of the game determined by the card distributing device 3 in each game by analyzing a video of the state of process of the game through the image analyzing device 12. In a case where a determination result acquired through an analysis using the image analyzing device 12 is different from a result (for example, a result of reading using an RFID) of reading using the other means, the intelligent-type control device 14 stores the analysis image and can verify the result later. As a result of the verification, in the case of an error in the intelligent-type control device 14, by using the analysis image as sample data of teacher leaning in the deep-learning technology, the accuracy of the intelligent-type control device 14 can be improved.

The control device 14 can analyze and acquire a total amount of the game tokens 120 in the game token tray 17 for the dealer 5 in the game table 4 by using the image analyzing device 12 and can compare and calculate whether or not a total amount of the game tokens 120 inside the tray 17 for the game tokens 120 has been increased or decreased according to the amount of collection of the losing game tokens 120 bet by each player 6 and the amount of the payment 120W for winning game tokens to a player 6W who has won after the end of the game and the settlement based on a result of winning/losing of the game. A total amount of the game tokens 120 in the tray 17 for game tokens 120 may be constantly acquired using means such as an RFID, and the control device 14 determines whether or not the increased/decreased amount is correct by analyzing the video of the state of progress of the game through the image analyzing device 12.

For this, the artificial intelligence-type or deep-leaning structure is also used.

In this example, since fraud or a mistake is detected based on a result of winning/losing of a game, information of the type of bet game token 120, the position (a player, a banker, or a pair) inside the bet area 8 on which the game tokens 120 are bet, and the quantity of the game tokens 120, and an increased/decreased amount of the game tokens 120 in the game token tray 17 after the end of the collection of losing game tokens and the repayment for the won game tokens 120 without acquiring the movement of the game tokens 120 after the end of the game, that is, whether the bet game tokens 120 have been moved to the player side or the dealer side.

For example, in the case of Baccarat, a result of winning/losing of a game can be determined based on rules of Baccarat by reading ranks of cards C delivered in that game by the card distributing device 3. In addition, a result of winning/losing of a game can be determined also by imaging an area on the game table 4 by using the camera device 2, analyzing the image using the image analyzing device 12, and collating a result of the analysis with the rules of the game by using the control device 14. In such a case, a winning/losing result determining device is configured by the camera device 2, the image analyzing device 12, and the control device 14. The information of a player of each play position 7, the type of bet game token 120, the position (a player, a banker, or a pair) inside the bet area 8 on which the game tokens 120 is bet, and the quantity of the game tokens 120 is acquired by imaging the game tokens 120 placed on the bet area 8 by using the camera device 2 and analyzing the image for each play position 7 by using the image analyzing device 12.

In addition, an increased/decreased amount of game tokens 120 in the game token tray 17 before and after the collection of losing game tokens 120 and the repayment for winning game tokens 120 can be calculated by comparing a total amount of the game tokens 120 disposed inside the game token tray 17 before the collection of losing game tokens 120 and the repayment for won game tokens 120 with a total amount of the game tokens 120 disposed inside the game token tray 17 after the collection of losing game tokens 120 and the repayment for won game tokens 120.

The total amount of the game tokens 120 disposed inside the game token tray 17 before the collection of losing game tokens 120 and the repayment for won game tokens 120 and the total amount of the game tokens 120 disposed inside the game token tray 17 after the collection of losing game tokens 120 and the repayment for won game tokens 120 can be detected by imaging the game token tray 17 housing the game tokens 120 using the camera device 2 and analyzing the image using the image analyzing device 12. In addition, by embedding an RFID representing the amount inside game tokens 120 and arranging an RFID reader in the game token tray 17, a total amount of the game tokens 120 housed in the game token tray 17 may be configured to be detected.

For example, it is assumed that the total amount of the game tokens 120 disposed on the game token tray 17 before the start of a game is Bb, and the total amount of the game tokens 120 disposed on the game token tray 17 after the game ends, and the collection of losing game tokens 120 and the re-payment for winning game tokens 120 is Ba. In addition, in this game, a total amount of all the play positions 7 of game tokens 120 that is bet on the player area is bp, a total amount of all the play positions 7 of game tokens 120 that is bet on the banker area is bb, and a total amount of all the play positions 7 of game tokens 120 that is bet on a tie area is bt. For example, in a case where a result of winning/losing of a game is the winning of the banker, Ba−Bb=bp−bb+bt needs to be satisfied. Alternatively, the total amount Ba of the game tokens 120 of the game token tray 17 after the end of the game needs to be (Bb+bp−bb+bt). Otherwise, it can be determined that there is fraud or a mistake in the collection or repayment of the game tokens.

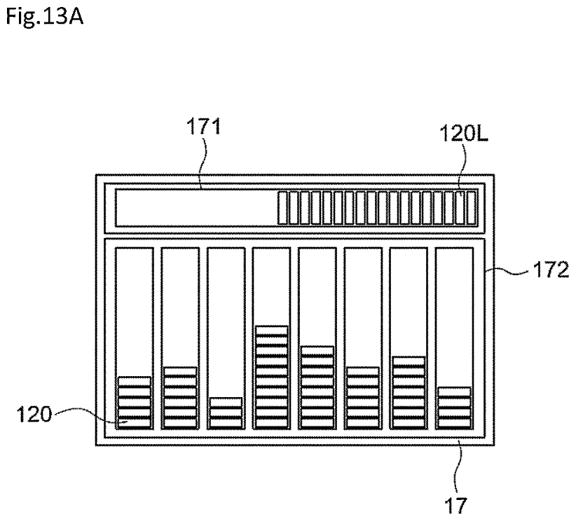

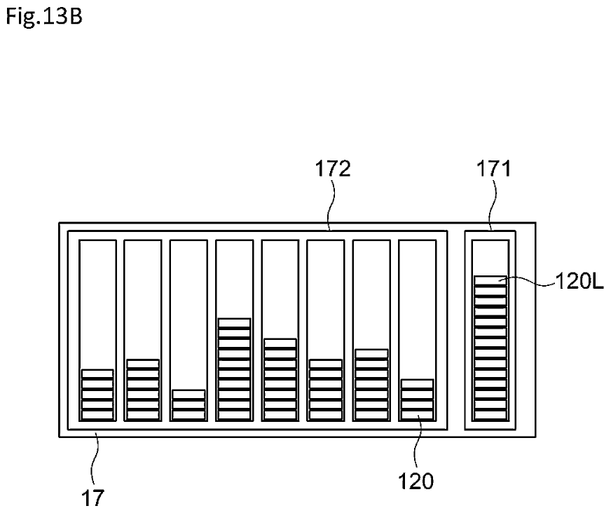

FIG. 13A is a diagram illustrating details of a game token tray according to this embodiment, and FIG. 13B is a diagram illustrating another example of a game token tray. In the game token tray 17, a collection tray 171 for game tokens that is used for collecting and temporarily storing game tokens 120L that is bet by a losing player 6L and a repayment tray 172 for game tokens 120W that is used for storing game tokens 120L to be re-payed are arranged. The image analyzing device 12 and the control device 14 acquire the position, the type, and the quantity of game tokens 120L that is bet by the losing player 6L and calculates an increased amount (an amount of game tokens 120 to be present in the collection tray 171 for game tokens) of game tokens 0L in the game. In addition, the image analyzing device 12 and the control device 14 acquires a real total amount of game tokens 120 in the tray 171 for game tokens after the collection and compare a total amount with the real total amount to determine whether or not there is a difference therebetween.

In addition, for the repayment of game tokens 120W for a winning player 6W, by using game tokens 120 that are present in the repayment tray 172 for game tokens, a sufficient time can be secured for the image analyzing device 12 and the control device 14 to acquire a real total amount of game tokens 120 in the collection tray 171 for game tokens after collection.

As illustrated in FIG. 1, the game table 4 includes a disposal area 41 and/or a disposal slot 42 used for disposing cards C used in a game. When a game ends, the cards C used in the game are collected and are put into the disposal area 41 or the disposal slot 42 on the game table 4.

The game table 4 further includes a marker 43 representing winning/losing of a game.

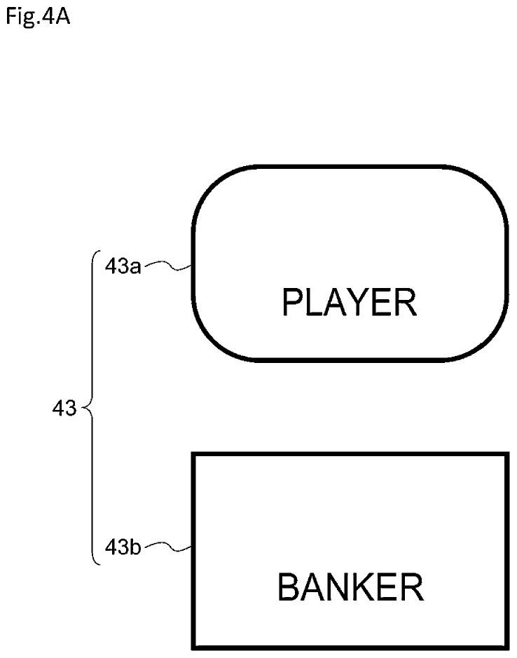

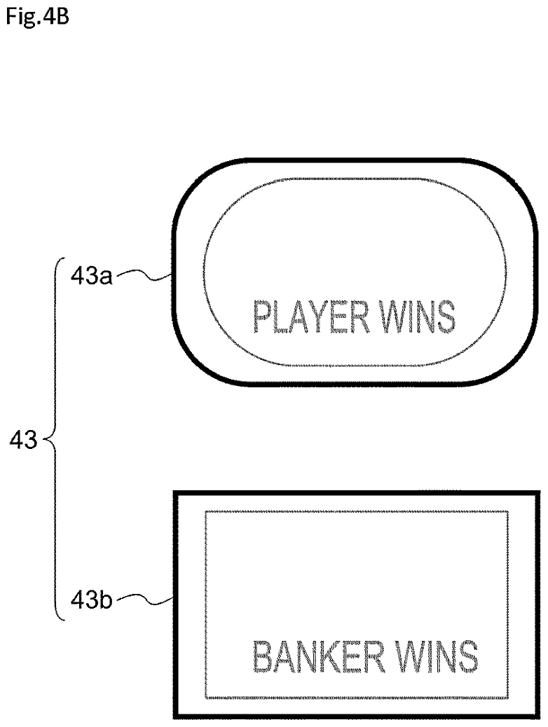

FIG. 4A is a plan view illustrating the front side of a marker, and FIG. 4B is a plan view illustrating the back side of a marker. In a Baccarat game, two types of a marker 43a representing the winning of the player and a marker 43b representing the winning of the banker are used, and, when a result of a game comes out, the dealer 5 overturns the marker of the winning side out of the player or the banker. In this way, winning/losing of a game is represented on the table to be easily understood. The overturned marker is returned to the original state by the dealer 5 after the collection and the repayment of game tokens 120. By returning the marker to the original state, it also represents a state in which a next game can be started.

As above, in this embodiment, the control device 14 calculates the amount of bet game tokens on the game table 4 and a balance of game tokens from a result of winning/losing of a game for each game and verifies an increased amount of the balance of game tokens inside the game token tray 17 after the game. When a difference is detected in this verification, the control device 14 generates an alarm or adds recording of an indication thereof in the recording of a video captured by the camera device 2. A casino operator can peruse the reason for the difference by checking the video.

The fraud detecting system according to this embodiment adds/subtracts an increased/decreased amount of game tokens in a game calculated based on the positions, the types, and the quantities of game tokens 120 that is bet by all the players 6 in the game and a result of winning/losing of the game acquired by the winning/losing result determining device to/from a total amount of game tokens 120 in the game token tray 17 before a settlement of each game, compares a total amount of game tokens 120 to be present in the game token tray 17 after the settlement at the time of the end of the game with a real total amount of game tokens 120 in the game token tray 17 at the time of end of the game that is acquired through the image analyzing device 12, and determines whether or not there is a difference between a total amount and a real total amount.

The control device 14 acquires the position, the type, and the quantity of game tokens that is bet by each player through the image analyzing device 12, acquires a real total amount of game tokens placed in the game token tray when all the collections of losing game tokens bet by each player end, compares a total amount of game tokens 120 to be present in the game token tray 17, which is acquired by adding an increased amount in the game token tray 17 in the game based on the positions, the types, and the quantities of game tokens bet by losing players to a total amount of game tokens placed in the game token tray before a settlement of each game, with a real total amount of game tokens 120 placed in the game token tray 17, and determines whether or not there is a difference between the total amount and the real total amount.

In a case where the control device 14 compares a total amount of game tokens 120 to be present in the game token tray 17, which is acquired by adding an increased amount in the game token tray 17 in the game based on the positions, the types, and the quantities of game tokens 120 bet by losing players to a total amount of game tokens 120 placed in the game token tray 17 before a settlement of each game, with a real total amount of the game tokens 120 placed in the game token tray 17, and determines that there is no difference between the total amount and the real total amount, and compares a total amount to be present in the game token tray 17 after the settlement at the time of end of the game with a real total amount of game tokens 120 placed in the game token tray 17 at the time of end of the game acquired through the image analyzing device 12, and determines that there is a difference between the total amount and the real total amount, the control device 14 determines a mistake in the payment and generates a payment error signal used for giving a notification of the mistake in the payment.

In the game token tray 17, the collection tray 171 for game tokens that collects and temporarily stores game tokens 120 bet by losing players is arranged, and the image analyzing device 12 compares a total amount of game tokens 120 to be present in the collection tray 171 for game tokens, which is acquired by adding an increased amount of game tokens 120 in the game that is calculated based on the positions, the types, and the quantities of the game tokens 120L bet by losing players, with a real total amount of the game tokens 120 placed in the tray 171 for game tokens, and determines whether or not there is a difference between the total amount and the real total amount.

When the control device 14 determines a difference in the real total amount of the game tokens 120 acquired from the game token tray 17 for the dealer 5 of the game table 4 not corresponding to the increased/decreased amount of the game tokens calculated based on the amount of game tokens bet by all the players and a result of winning/losing of the game, the game recording device 11 assigns an index or time to the acquired video or can reproduced with a collection scene or a payment scene of the game tokens 120 specified such that the recording of the game in which the difference occurs can be analyzed by the game recording device 11.

In this way, the control device 14 acquires a total amount of game tokens (chips) placed in the game token tray 17 after a settlement at the time of end of a game through the image analyzing device 12. In this case, the determination of “after the settlement” is when one of 1) to 4) described below occurs: 1) when repayment for won game tokens 120 (won chips) ends; 2) when cards C used in the game are collected and are disposed in the disposal area or the disposal slot of the table; 3) when a predetermined button accompanying the winning/losing result determining device is pressed; and 4) when the marker 43 representing winning/losing is returned to the original state

In the management system of the table game, the management control device images the positions, the types, and the quantities of game tokens that is placed by game participants in each game when any one of 1) to 3) described below is detected: 1) when the card distributing device detects that a first card is drawn; 2) before and after drawing; and 3) after the management control device recognizes a dealer's bet end sign

In addition, the control device 14 has an artificial intelligence-utilizing or deep-learning structure capable of acquiring the position (a position for betting on the player, the banker, or the fair) and the amount (the types and quantities) of bet game tokens at each player position 7 of the game table 4, comparing a winning/losing history of each player 6 and the amount (won amount) of acquired game tokens that can be acquired based on the result of winning/losing of each game with statistical data of many (big data) games in the past, and extracting an abnormal situation (set in the casino).

Typically, the control device 14 is included which has an artificial intelligence-utilizing or deep-learning structure capable of extracting an occurrence of a won amount of a certain amount (one million dollars) or more and an abnormal situation in which, in a play position 7 of a specific game table 4, a state in which the amount of bet game tokens is small at the time of losing a game, and the amount of bet game tokens is large at the time of winning a game is continued for several games and is determined as an abnormal situation based on a comparison with statistical data (big data or the like) of games in the past.

In addition, the control device 14 (integrated with the image analyzing device 12) of the fraud detecting system has a structure capable of extracting an abnormal situation or specifying an individual player 6 at the play position 7 at which winning of a predetermined amount of more is acquired. In such specifying of a player 6, the image of each face is specified with a profit and an identify number (an ID or the like) assigned thereto in the image analyzing device 12. Then, the control device 14 has a warning function for giving a notification of the presence of a specific player in another game table when the specified player 6 leaves a seat and arrives at the another game table. More specifically, a notice is given to a pit manager managing each game table 4 or each table staff (or a dealer), wherein further prevention of an abnormal phenomenon is achieved.

The control device 14 includes a database recording a history of exchange of bills K and game tokens 120, refers to the database at the interval of a predetermined time or in units of one day and determines through a comparison whether or not the amount of game tokens 120 acquired in the game token tray 17 for the dealer 5 of the game table 4 has been increased or decreased according to a payed amount of game tokens 120 corresponding to exchanged bills K or a total amount of payment of bills K corresponding to exchanged game tokens 120.

In addition, a winning/losing history of each play position 7 and the amount (won amount) of acquired game tokens may be monitored without specifying an individual player 6.

In such a case, while, in a case where each player 6 leaves the seat, the player 6 cannot be tracked, an abnormal situation such as a case where, a state in which the amount of bet game tokens is small at the time of losing a game at a specific play position 7 of one game table 4, and the amount of bet game tokens at the time of winning a game is large is continued for several games or the like can be detected. Then, in a case where such a play position 7 is detected, there is a suspicion that there is fraud or a mistake at the play position 7. Then, by verifying a video in which the play position 7 is imaged, a fraud or a mistake can be found.

More specifically, the camera device 2 is mounted to image at least game tokens 120 placed in the bet area 8 of the game table 4. The image analyzing device 12 analyzes images captured by the camera device 2 and detects a position among the positions of the player, the banker, and the tie of the bet area 8 at which game tokens are placed for each user position 7 and the amount of the placed game tokens. In addition, the card distributing device 3 also functions as a winning/losing result determining device and determines a result of winning/losing of a game. The control device 14, based on the position (the player, the banker, or the tie) inside the bet area 8 at which the game tokens 120 are placed and the result of winning/losing of the game, records monitors) a winning/losing history for each play position 7 and the amount (an acquired amount of the game tokens) of the game tokens that has been acquired. Here, any one of the winning/losing history and the acquired amount of the game tokens may be recorded. In a case where the winning/losing history/or the acquired amount of the game tokens is in an abnormal situation (set in the casino) when compared with the statistical data of many (big data) games in the past, the control device 14 specifies this player position 7 as a play position at which a suspicion of fraud is present.

In a case where there is a suspicion of fraud for a specific player position 7, the fraud detecting system may be configured to generate an alarm (light, a sound, or a vibration) such that at least the dealer gets near at the time point. In this way, a game thereafter is stopped at least at the place or the like, and the continuation of fraud can be blocked. In addition, information representing a suspicion of fraud may be added to a video that is captured and recorded by the camera device 2. Accordingly, by checking the video, the cause of the suspicion of fraud can be investigated.

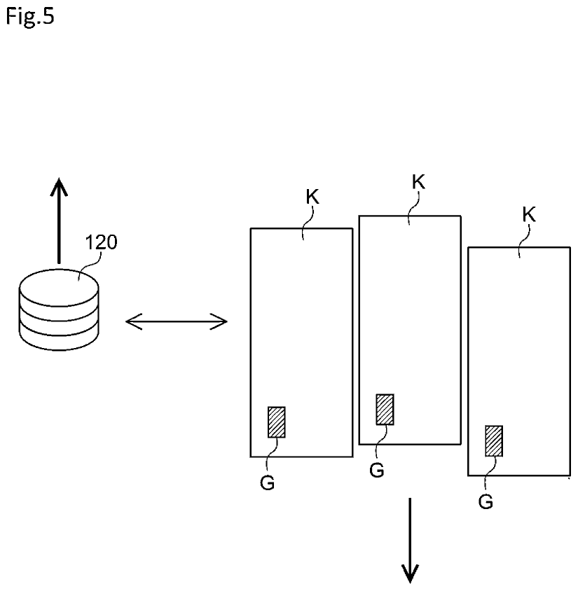

The fraud detecting system in a game house including a game table according to this embodiment further has a function of performing an inspection at the time of exchange of bills and game tokens that is frequently performed in the game table 4. In a game house such as a casino, before a game, a player 6 exchanges bills (cash or the like) and game tokens at a predetermined game tokens clearing house. However, when all the game tokens are used, the player 6 can continue the game by exchanging cash (bills) with game tokens 120 on the game table (a Baccarat table or the like) without leaving the seat from the game table 4. However, here, there is a chance for fraud between the dealer 5 and the player. The exchange of cash (bills) for game tokens 120 on a game table (for example, a Baccarat table or the like) needs to be performed when a game does not advance. In order to determine winning/losing of a game, the card distributing device 3 can detect the start of dealing of cards and the end of dealing (a time period for determining winning/losing). For this reason, the card distributing device 3 detects a situation other than the distribution (dealing) of cards, and the control device 14 detects exchange of bills and game tokens 120 on the game table 4 in a situation other than the dealing of cards (illustrated in FIG. 5).

Being in the middle of the dealing (or any other situation) of cards can be detected based on information acquired from the operation of the card distributing device 3 or the dealer 5.

The control device 14 can recognize the quantity and the amount of bills by performing an image analysis of the surfaces of the bills K. In addition, in the game table 4, it is determined whether or not bills K to be exchanged for game tokens 120 are genuine by detecting genuine marks G of the bills by emitting black light. As illustrated in FIG. 5, the control device 14 has an artificial intelligence-utilizing or deep-learning structure verifying the genuine marks G through an image analysis, recognizing a total amount of genuine bills, being capable of recognizing a total amount of game tokens even in a state in which a plurality of game tokens come out onto the game table as an exchange target is hidden due to a blind area of the camera device 2, comparing a total amount of the bills K come out onto the game table 4 from a player with a total amount of the game tokens 120 come out from the dealer 5, and being capable of determining whether or not both the amounts match each other.

The control device 14 has an artificial intelligence-utilizing or deep-leaning structure capable of determining whether or not a total amount of game tokens 120 placed in the game token tray 17 for the dealer 5 of the game table 4 has been increased/decreased according to a paid amount of game tokens corresponding to the exchanged bills after a settlement through exchange of the bills and the game tokens. A case may be considered as well in which the total amount of the game tokens 120 placed in the game token tray 17 for the dealer 5 is constantly acquired in advance by using RFIDs of game tokens 120 or the like. In addition, the total amount of the game tokens 120 housed in the game token tray 17 can be detected by imaging the game token tray 17 housing the game tokens 120 by using the camera device 2 and analyzing the image using the image analyzing device 12.

In addition, the control device 14 detects whether an increase/decrease in the amount of the game tokens 120 present inside the game token tray 17 before and after the exchange of bills and the game tokens matches an exchange amount of the game tokens as a result of an image analysis on the game table 4. The amount of paid bills may be input by the dealer 5 to the control device 14 through key input or the like or may be specified by imaging an area disposed on the game table 4 in which bills are paid by using the camera device 2 and analyzing the image using the image analyzing device 12.

As described above, the control device 14 determines whether or not a decreased amount of the game tokens 120 from the game token tray 17 according to the exchange of bills and the game tokens matches the amount paid to the dealer 5 from players 6. In addition, the control device 14 is an intelligence-type control device capable of determining match/mismatch of an input amount (commonly, according to key input or the like) of bills input by the dealer 5 and a calculated amount of bills that is a result of an image analysis performed by the image analyzing device 12 after the settlement through the exchange of the bills and the game tokens through a comparison and calculation and may have an artificial intelligence-utilizing or deep-learning structure.

Furthermore, the control device 14 has an artificial intelligence-utilizing or deep-learning structure capable of determining match/mismatch of a total amount of bills according to the input of a dealer in the game table 4 for which the dealer is responsible and a total amount of bills according to a result of an image analysis using the image analyzing device 12 through a comparison and calculation.

The control device 14 determines whether or not the amount of game tokens 120 perceived in the game token tray 17 for the dealer 5 of the game table 4 has increased/decreased according to a paid amount of game tokens 120 corresponding to exchanged bills after the exchange of the bills and the game tokens 120 or a paid amount of bills corresponding to the exchanged game tokens 120 through a comparison.

The control device 14 is a control device having an artificial intelligence-utilizing or deep-learning structure capable of acquiring information of the types and the quantities of the game tokens 120 even in a state in which a part of or the whole one unit of game tokens is hidden when the types and the quantities of the game tokens 120 are determined.

A management system according to a second embodiment relates to a management system of table games in a game house.

In a game house such as a casino, there are various attempts preventing dealer's mistakes in handling game tokens (substitute currency for gaming). A game house includes monitoring cameras used for monitoring dealer's mistakes in handling game tokens, and such mistakes are prevented using a determination of mistakes and fraud according to collection and repayment of game tokens that are different from a result of winning/losing based on images acquired using the monitoring cameras and the like.

Meanwhile, in order to acquire the quantity and a total amount of game tokens, it has been proposed to acquire the amount of the game tokens by attaching an IC tag to each game token.

In a card game monitoring system disclosed in PCT App. PCT/JP2015/000171, it is determined whether or not game tokens place on a game table is collected or re-payed according to a result of winning/losing by performing an image analysis of movement of the game tokens, and monitoring of dealer's mistakes in handling the game tokens is performed.

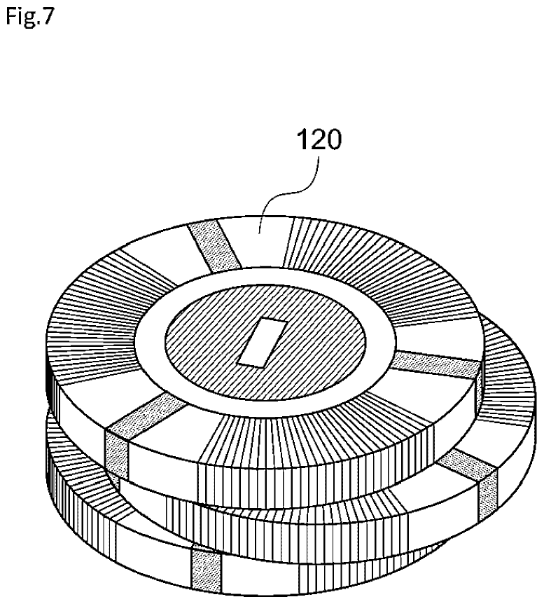

In game houses such as casinos, while game tokens are piled to have a high volume and is placed on a game table, there is a problem in that a total amount cannot be correctly read by a reading device for IC tags disposed under the game table, and, when the sensitivity of the reading device is increased, game tokens placed at a different position (winning/losing depends on the position) is added, and there is a problem in that a total amount of game tokens at each position cannot be perceived. In addition, conventionally, as illustrated in FIG. 7, the pattern of game token (substitute currency for gaming) 9 is complicated, and, when a plurality of game tokens are piled, there is a problem in that the quantity of such a pile cannot be accurately acquired using a camera.

Furthermore, fraud on a game table has been advanced, and there is a new problem in that fraud using an advanced betting method or the like that cannot be found in simple detection of a large winning amount on a game table or the like cannot be found by using a camera.

In addition, it is necessary for a dealer to collect or re-paid game tokens placed on a game table according to a result of winning/losing. In a case this is to be determined by performing an image analysis of the game tokens, since the pattern of the game token (substitute currency for gaming) is complicated, there is a problem in that it cannot be determined whether or not a dealer correctly performs re-payment when game tokens corresponding to the bet game tokens are re-payed by using a currently-existing practical image analyzing technology, and the prevention of mistakes is not sufficient.

In order to solve the various problems described above, a management system of table games according to this embodiment includes: a card distributing device that determines and displays a result of winning/losing of each game in a game table; a measurement device that measures the types and the quantities of game tokens place on the game table by using a camera; and a management control device that specifies and stores the position, the types, and the quantity of game tokens placed on the game table by a game participant by using a result of the measurement performed by the measurement device in each game. The game token has a configuration in which a plurality of plastic layers of different colors are stacked, at least a coloring layer is included in the middle, and a stripe pattern in a stacking direction is formed on a side face by employing a multi-layer structure in which white layers or thin-color layers are stacked on both sides of the coloring layer disposed in the middle, and the type of the game token can be specified by using the coloring layer. The management control device has calculation functions of determining a winner and a loser among participants in each game by using a result of winning/losing acquired from the card distributing device and a result of the measurement of the position, the types, and the quantities of the game tokens placed by each game participant and calculating the balance of the casino side in the game table for each game.

In addition, in the management system, the management control device has a structure including a function of determining the quantity of the game tokens by measuring the number of coloring layers, the white layers, or the thin-color layers of the game tokens placed by each game participant.

In order to solve the various problems, game token according to this embodiment has a configuration in which a plurality of plastic layers of different colors are stacked, at least a coloring layer is included in the middle, and a stripe pattern in a stacking direction is formed on a side face by stacking white layers or thin-color layers on both sides of the coloring layer, and the type of the game token can be specified by using the coloring layer.

In addition, in the game token, on the surface of the white layer or the thin-color layer, a print representing the type of the game token is formed, transparent layers are disposed in outermost layers, and each interlayer is thermos-compressed to form a structure of at least five layers.

In addition, in the game token, marks using UV ink or ink (carbon black ink) absorbing infrared rays are arranged on the surfaces of the white-color layers or the thin-color layers, or embossing processing is performed for the transparent layer of the outermost layer, or R processing is performed for the ends of the transparent layers of the outermost layers, or the coloring layer is formed by a plurality of layers, and RFIDs may be built in the coloring layers.

In order to solve the various problems described above, an inspection device inspecting game tokens according to this embodiment includes: a passage including an inlet and an output through which the game tokens can pass in a radial direction; a game token type determining device that determines a color of the stripe in the staking direction of the side face by imaging the side face of the game token passing through the passage; a mark reading device that reads a mark, which is formed using the UV ink or the ink (carbon black ink) absorbing infrared rays, arranged on the surface of the passing game token; a print inspecting device that reads a print representing the type arranged on the surface of the game token in a vertical direction with respect to the passage; and a control device of the whole device. The control device is configured to inspect whether or not the type of the game token determined by the game token type determining device matches a content of the print representing the type acquired by the print inspecting device.

According to the system of this embodiment, even in a case where many game tokens (substitute currencies for gaming) are piled up, the quantity of the game tokens can be determined, and a total amount of relatively overlapping game tokens can be acquired based on the position and the color.

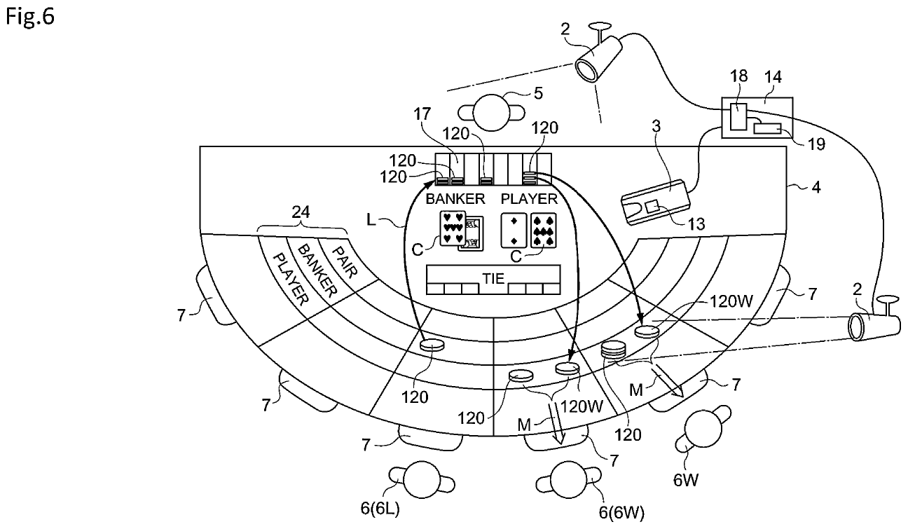

Hereinafter, a management system of table games in a game house including a game table according to an embodiment of the present invention will be described. FIG. 6 is a diagram that illustrates an overview of the whole system. The management system of table games in a game house including a plurality of game tables 4 includes: a measurement device 19 including an image analyzing device 18 that records a state of process of a game played in the game table 4 as a video including game participants 6 and a dealer 5 through a plurality of camera devices 2 and performs an image analysis of the recorded video of the state of process of the game; and a card distributing device 3 that determines and displays a result of winning/losing of each game in the game table 4. The card distributing device 3 is a so-called electronic shooter that has already been used by persons skilled in the art and has rules of a game programmed in advance and has a structure capable of determining winning/losing of a game by reading information of distributed cards C. For example, in a Baccarat game, winning of the baker, winning of a player, or tie (drawn) is determined basically based on the ranks of two to three cards, and a determination result (a result of winning/losing) is displayed in a result display lamp 13.

The management control device 14 reads information (ranks and suits) of cards C acquired from the card distributing device 3 and determines a result of winning/losing of each game and determines a winner 6W and a loser 6L among the participants 6 in each game by using a result of measurement of the position, the types, and the quantities of game tokens 120 placed by the game participants 6.

In addition, the management control device 14 has a calculation function of calculating a balance (an amount acquired by subtracting a total amount of game tokens 120 that is re-paid to a winner 6W among the participants 6 from a total amount of game tokens 120 bet by the loser 6L) of the casino side in the game table 1 for each game.

The image analyzing device 18, the measurement device 19, and the management control device 14 of this detection system have a structure integrally including a computer formed as one body or by a plurality of configurations, a program, and a memory.

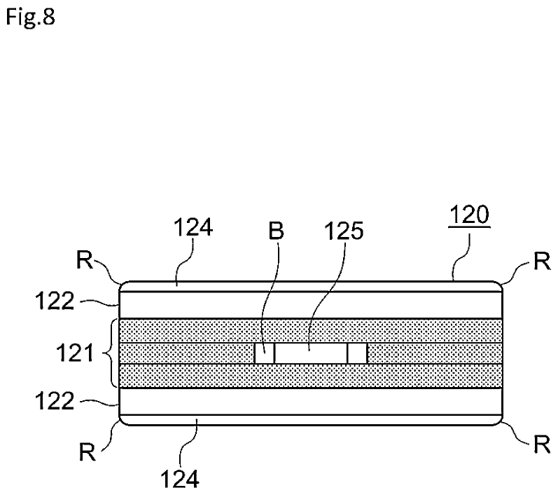

Next, details of game token used in this detection system will be described. FIG. 8 is a front cross-sectional view of a game token 120 used in this detection system. The game token 120 has a multi-layer structure in which a plurality of plastic layers having different colors are stacked, a coloring layer 121 is included at least in the middle, and white layers 122 or thin-color layers (while not illustrated in the drawing, the layers may be layers of a color that is thinner than that of the coloring layer 121) are stacked on both sides of the coloring layer 121 of the middle.

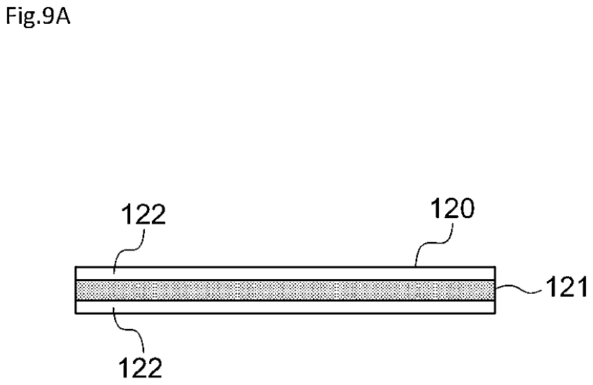

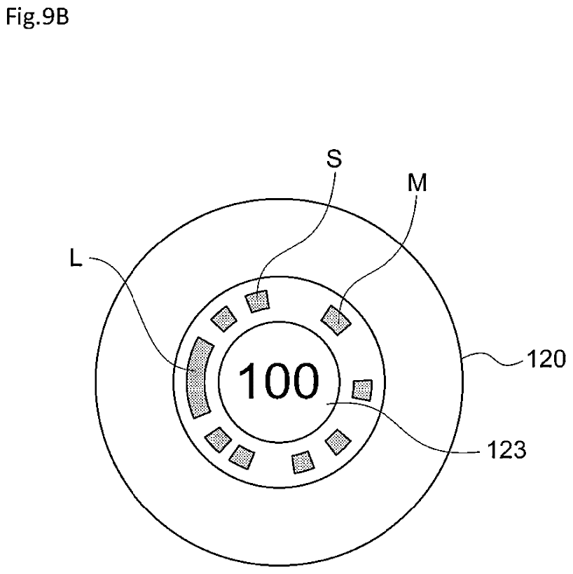

In this way, by employing a multi-layer structure in which the coloring layer 121 is included, and white layers 122 or thin-color layers (while not illustrated in the drawing, the layers may be layers of a color that is thinner than that of the coloring layer 121) are stacked on both sides of the coloring layer 121 of this middle, as illustrated in FIG. 9A, a stripe pattern is formed on the side face in the stacking direction, and the type of the game token 120 can be specified by changing the color (red, green, yellow, blue, or the like) of the coloring layer 121 for each type (10 points, 20 points, 100 points, 1000 points, and the like) of the game token 120.

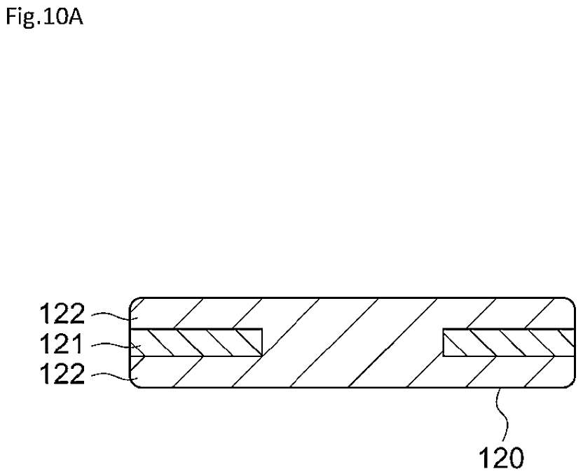

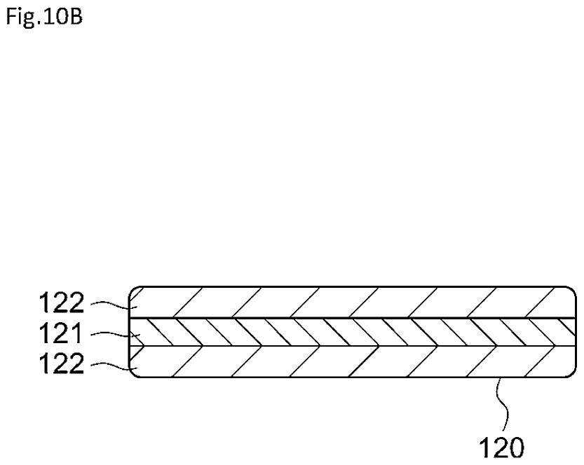

The game token 120 is configured as a structure body including the coloring layer 121 and the white layer 122 or the thin-color layer at least in the outer appearance to form a stripe pattern in the axial direction on the side face and has a configuration enabling the type of the game token 120 to be specified using the coloring layer 121. While FIGS. 10A and 10B illustrate different examples, in the examples, the coloring layer 121 and the white layer 122 or the thin-color layer are formed through injection molding, and so-called two-color molding is used in which, first, the coloring layer 121 is molded inside a die for molding (not illustrated in the drawing), and thereafter, the white layer 122 or the thin-color layer is molded.

In addition, as illustrated in FIG. 9B, in the game token 120, prints 123 (100 points or the like) representing the type of the game token 120 are formed on the surfaces (the upper face and the lower face) of the white layer 122. As illustrated in FIG. 8, the transparent layers 124 are disposed in the outermost layers, and each interlayer is thermos-compressed, and a structure of at least five layers is formed. Such game token 120 is formed by using a plastic material having a thin long shape, and layers (the coloring layer 121, the white layer 122, and the transparent layer 124) are thermo-compressed to form a closely adhering state (a structure of five layers or the like) in the state of a long length, and thereafter, holes having a circular shape, a rectangular shape, or the like are formed therein through press or the like.

When a hole is formed through the press, die of mold for punching, and the size of punching are designed, and R processing (round angle) is performed for the ends of the transparent layer 124 of the outermost layer.

That is, in order to manufacture the game token 120, first, a plate-shaped coloring layer 121 formed using plastic and a plate shaped white layer 122 or a thin-color layer formed using plastic are stacked, and a stacked structure body configured by a plurality of plastic layers is formed. Then, drawing patterns are printed on the upper face and the lower face of this stacked structure body, and transparent layers 124 are formed thereon. Then, the layers of the stacked structure body and the transparent layers 124 are heated and pressed to be heated and welded, whereby a game token original plate is generated. Then, punching processing is performed for the game token original plate acquired in this way, whereby a plurality of game tokens 120 having a predetermined shape are acquired. When this punching processing is performed, R processing is performed for upper and lower angles of the game token 120 using a mold.

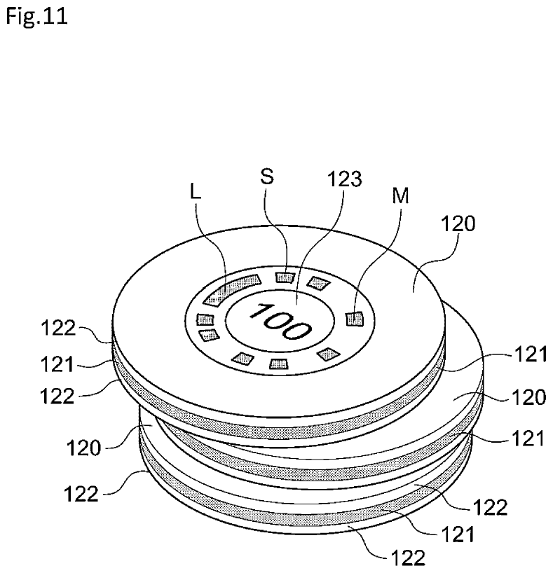

In addition, in the game token 120, face codes using the UV ink or ink (carbon black ink) absorbing an infrared rays are arranged on the surface of the white layer 122 (see FIG. 9B). This face codes represent the authenticity of the game token 120, and, when ultraviolet rays (or infrared rays) are emitted thereto, a mark is visible to the eyes, and a combination of the form and the number of the marks represents the authenticity. FIG. 11 is a perspective view of a state in which the game tokens 120 are stacked up, and a face code M is acquired by combining a long code L and a short code S. In the outermost layers, while transparent layers (print layers) 124 are thermally compressed or formed as coating layers to cover the print 123 and the face code, embossing processing is performed for these transparent layers 124, and the close adherence between the game tokens 120 is prevented. In addition, in this embodiment, while an example has been described in which face codes are printed on the surfaces of the white layers 122, instead of the face codes or together with the face codes, one or both of a security mark and an optically variable device (OVD) may be printed.

The R processing (R) is performed for the ends of the transparent layers (print layer) 124 of the outermost layer for which the print 123 (100 points or the like), and in the punching process of the game token 120, the surfaces of the white layers 122 are prevented from being deformed to appear on the side face. In addition, it is prevented that a sharp end remains in the game token 120 and damages the hands or the other game token 120.

The coloring layer 121, as illustrated in FIG. 8, may be formed by a plurality of colored layers (three layers in the case illustrated in FIG. 8). Since the plurality of colored layers (three layers in the case illustrated in FIG. 8) are thermos-compressed, a state in which the three-layer structure can be visually observed, as illustrated in FIG. 8, is not formed. However, three layers are illustrated in FIG. 8 for description. In addition, in a middle layer among the three layers of the coloring layer 121, a partly hollowed portion B is arranged, and an RFID 125 is built therein.

In addition, without arranging the hollowed portion B in the coloring layer 121, the RFID 125 may be built in the game token 120 by arranging the RFID 125 between the coloring layer 121 having a flat surface and the white layer 122 having a flat surface and performing thermos-compressing of the coloring layer 121 and the white layer 122 as it is. By configuring at least one of the coloring layer 121 and the white layer 122 using a material such as plastic that can be thermally deformed, out of the coloring layer 121 and the white layer 122 having the RFID 125 interposed therebetween through thermal compression, a plastic layer is thermally deformed, and accordingly, the RFID 125 is tightly fixed between such layers without arranging the hollowed portion B.

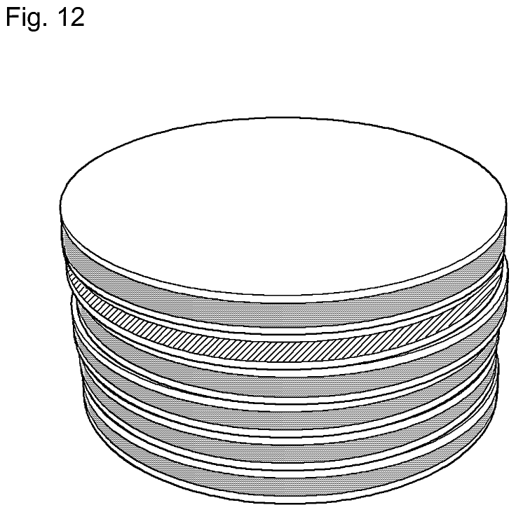

FIG. 12 is a perspective explanatory photographic diagram that illustrates a state in which game tokens of different types are piled up. The management control device 14 images game tokens 120 placed on the game table 1 by the game participant 6 by using the camera device 2 and measures each area 8 (whether the bet is on the banker, the player, the pair, or the tie) in which the game tokens 120 are placed by using the measurement device 19 including the image analyzing device 18, and the measurement device 19 (by using information acquired by the image analyzing device 18) analyzes and measures the number and the colors of coloring layers 121 (or the thin-color layers) or white layers 122 of the game token 120 that is stacked in each area and determines the types and the quantities of the game tokens 120. The management control device 14 performs control of the camera device 2 such that imaging using the camera device 2 is performed when the first card is drawn from the card distributing device, before and after the drawing, or after a dealer's sign representing the end of betting.

The management control device 14 may be a control device having an artificial intelligence-utilizing or deep learning structure. The management control device 14 can perceive the position 8 (a position betting on a player, a banker, or a pair), the types (a value of a different amount is assigned to the game tokens 120 for each color), and the quantities of the game tokens 120 that is bet by each participant 6 through the camera device 2 and the image analyzing device 18. The artificial intelligence-utilizing computer or control system can perceive the position 8 (a position betting on a player, a banker, or a pair), the types (a value of a different amount is assigned to the game tokens for each color), and the quantities of the game tokens 120 by using a self-learning function or the like in the deep-learning (structure) technology, and thus, according to a result of winning/losing of a game determined by the card distributing device 3 in each game, determines whether or not the collection (denoted using an arrow L) of game tokens 120 bet by a losing participant 6L and the re-payment (payment (120W)) for winning game tokens 120 for the winning game participant 6W are appropriately performed according to a result of winning/failure of the game in each game by analyzing a video of the state of progress of the game by using the management control device 14 through the image analyzing device 18.

In such a case, as illustrated in FIG. 11 (compared to conventional game tokens illustrated in FIG. 7), a stacked multi-layer structure is formed, and a stripe pattern is formed on the side face in the stacking direction, and accordingly, the measurement device 19 including the image analyzing device 18 can accurately perform the measurement of the types and the quantities of game tokens in an easy manner. In addition, by using an artificial intelligence-utilizing computer or control system and a deep-learning (structure) technology, the analysis and the determination of the image can be performed more accurately. The artificial intelligence-utilizing computer or control system and the deep-learning (structure) technology are known to persons skilled in the art and can be used, and thus, detailed description thereof will be abbreviated.

The management control device 14 can analyze and perceive a total amount of game tokens 120 in the game token tray 17 for the dealer 5 of the game table 4 by using the image analyzing device 18 and can determine through a comparison and calculation whether or not a total amount of the game tokens 120 placed inside the game token tray 17 has been increased/decreased according to the collection of the losing game tokens 120 bet by each game participant 6 and the amount of the payment 120W for winning game tokens to the winning game participant 6W after the game ends and is settled based on the result of winning/losing of the game. The total amount of the game tokens 120 in the game token tray 17 may be constantly acquired by using means such as RFIDs, and it is determined whether or not the increased/decreased amount is correct by the management control device 14 by analyzing a video of the state of progress of the game through the image analyzing device 18. For these, an artificial intelligence-utilizing or deep-learning structure may be utilized.

In addition, the management control device 14 may have an artificial intelligence-utilizing or deep-learning structure capable of acquiring the position (a position for betting on the player, the banker, or the fair) and the amount (the types and quantities) of bet game tokens at each player position 7 of the game table 4, comparing a winning/losing history of each player 6 and the amount (won amount) of acquired game tokens that can be acquired based on the result of winning/losing of each game with statistical data of many (big data) games in the past, and extracting an abnormal situation (set in the casino). Typically, the management control device 14 is included which has an artificial intelligence-utilizing or deep-learning structure capable of extracting an occurrence of a won amount of a certain amount (one million dollars) or more and an abnormal situation in which, in a play position 7 of a specific game table 4, a state in which the amount of bet game tokens is small at the time of losing a game, and the amount of bet game tokens is large at the time of winning a game is continued for several games and is determined as an abnormal situation based on a comparison with statistical data (big data or the like) of games in the past.

The total amount of the game tokens 120 in the game token tray 17 for the dealer 5 of the game table 4 is settled for the game tokens 120 bet by each participant 6 after each game, and the management control device 14 has a structure capable of determining through a comparison and calculation whether or not an increase/decrease in the game tokens that corresponds to a settlement is correct after the settlement.

In the game token tray 17 used for storing the game tokens 120 for the dealer 5 illustrated in FIG. 6, the types and the quantities of the game tokens 120 can be determined by analyzing and measuring the numbers and the colors of the coloring layers 121 or the white layers 122 of the game tokens 120 stacked in the horizontal direction by using the measurement device 19 (by using the information acquired by the image analyzing device 18). The total amount of the game tokens 120 for the tray 17 for storing game tokens is constantly (or at predetermined time intervals) acquired in this way. As the management control device 14 has a calculation function of calculating a settlement amount (calculation of a balance of the casino side in the game table 4 (an amount acquired by subtracting a total amount of the game tokens 120 re-paid to the winner 6W among the participants 6 from a total amount of the game tokens 120 bet by the loser 6L) of each game for each game (see description presented above), the total amount of the game tokens 120 of the game token tray 17 is constantly (or at intervals of a predetermined time) is verified. That is, it is verified whether or not an increase/decrease in the game tokens matches a result of an image analysis performed by the image analyzing device 18 and the settlement amount of each game performed by the dealer 5.

FIG. 13A is a diagram that illustrates details of a game token tray according to this embodiment, and FIG. 13B is a diagram that illustrates another example of the game tokens. In the game token tray 17, a collection tray 171 for game tokens that is used for collecting and temporarily storing game token 120L that is bet by a losing player 6L and a repayment tray 172 for game tokens 120W that is used for storing game tokens 120L to be re-payed are arranged. The image analyzing device 12 and the control device 14 acquire the position, the type, and the quantity of game tokens 120L that is bet by the losing player 6L and calculates an increased amount (an amount of game tokens 120L to be present in the collection tray 171 for game tokens 120) of game tokens 120L in the game. In addition, the image analyzing device 12 and the control device 14 acquire a real total amount of the game tokens 120 in the tray 171 for game tokens after the collection and determine whether or not there is a difference between the total amount and the real total amount through a comparison.

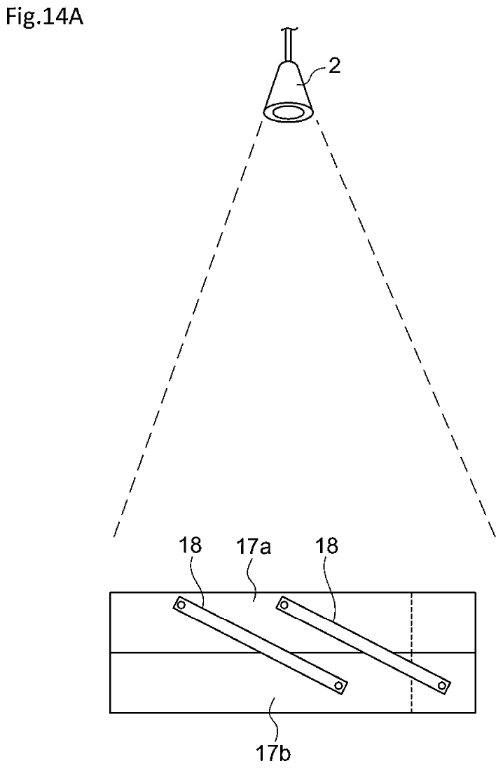

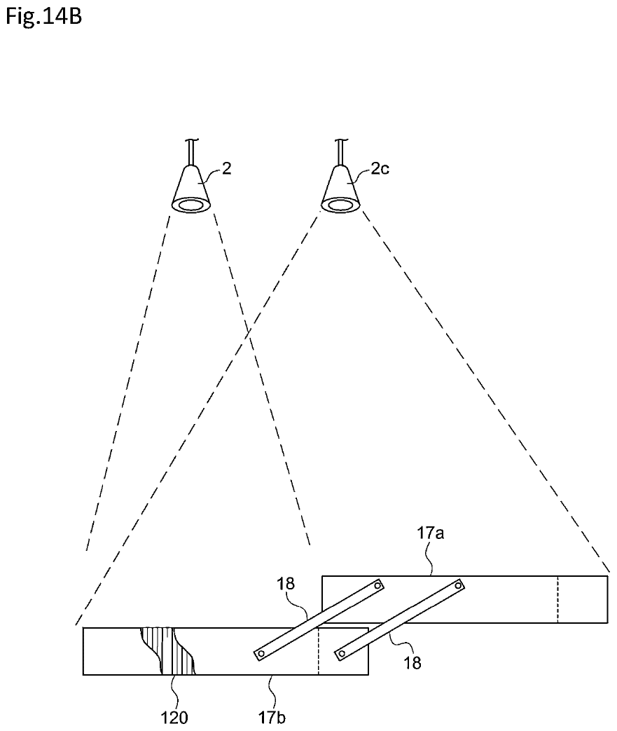

Here, the game token tray 17 that is illustrated above has a two-stage structure formed by an upper stage tray 17a for game tokens and a lower stage tray 17b for game tokens. FIGS. 14A and 14B are diagrams that illustrate a relation between the game token tray 17 having a two-stage structure and a camera device 2, FIG. 14A illustrates a state in which two stages overlap each other, and FIG. 14B illustrates a state in which two stages are shifted from each other. In the lower stage of the upper stage tray 17a for game tokens, the lower stage tray 17b for game tokens is present, and the upper stage tray 17a for game tokens and the lower stage tray 17b for game tokens are connected through a hinge 17c. In a case where game tokens 120 placed in the upper stage tray 17a for game tokens 120 are insufficient, game tokens 120 are supplemented from the lower stage tray 17b for game tokens to the upper stage tray 17a for game tokens. On the other hand, in a case where game tokens 120 placed in the upper stage tray 17a for game tokens are excessive, the game tokens are moved to the lower stage tray 17b for game tokens.

In order to take in the game tokens 120 from the lower stage tray 17b for game tokens, the upper stage tray 17a for game tokens is moved using the hinge 17c to be in a state illustrated in FIG. 14B. In the state illustrated in FIG. 14A, the upper stage tray 17a for game tokens is imaged by the camera device 2, and, in the state illustrated in FIG. 14B, the lower stage tray 17b for game tokens can be imaged using the camera device 2. In the state illustrated in FIG. 14B, the upper stage tray 17a for game tokens and the lower stage tray 17b for game tokens can be imaged by the camera device 2c simultaneously and in a state in which the trays can be identified from each other. In addition, in the state illustrated in FIG. 14B, the upper stage tray 17a for game tokens and the lower stage tray 17b for game tokens may be separately imaged. The camera devices 2 and 2c may respectively include a visible light camera corresponding to printed ink of a side ID 126 and an infrared-ray camera or may be cameras switchable between a plurality of functions of a visible-light camera corresponding to printed ink and an infrared-ray camera.

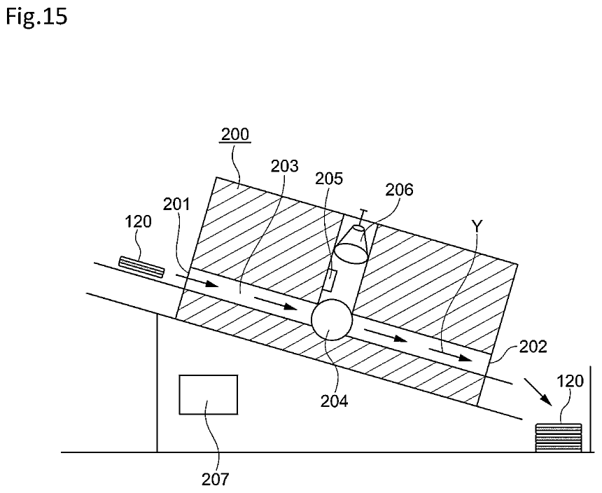

Next, an inspection device 200 inspecting the game token 120 according to an embodiment of the present invention will be described with reference to FIG. 15. The inspection device 200 includes a passage 203 that includes an inlet 201 through which game token 120 can pass in the radial direction (the direction of an arrow Y) and an outlet 202. The passage 203 inclines, and the game token 120 passes in the direction of the arrow Y). In the passage 203, a game token type determining device 204 that images the side face of the game token 120 and determines the color of a stripe pattern of the side face in the stacking direction; a mark reading device 205 that reads a face code as a face code using UV ink or ink (carbon black ink) absorbing infrared rays arranged on the surface of the passing game token 120; a print inspecting device 206 that reads the print 123 representing the type arranged on the surface of game token in the vertical direction with respect to the passage 203; and a control device 207 for the whole device. The control device 207 is configured to inspect whether or not the type of the game tokens determined by the game token type determining device 204 matches a content of the print representing the type acquired from the print inspecting device 206.

By using this inspection device 200, it can be inspected whether or not the print 123 of the manufactured game token 120 matches the type of the game token according to the color of the stripe pattern of the game token 120 and is correctly printed.

As above, the game token 120 according to this embodiment has a stacked structure, in which the coloring layer 121 and the white layer 122 or thin-color layers having the coloring layer 121 interposed therebetween are stacked, formed by a plurality of plastic layers and thus, has a side face on which a stride pattern is formed in the stacking direction. The game token 120 has a configuration enabling the type of the game token 120 to be specified using the coloring layer 121 appearing on the side face. In addition, prints are performed for the upper face and the lower face of the game token 120. More specifically, prints are performed for the surface of the white layer 122 of the thin-color layer, and the transparent layer 124 is included on the upper face thereof. The coloring layer 121 and the white layer 122 or the thin-color layer and the print layer 124 are thermos-compressed together to form a layered structure.

The white layers 122 or the thin-color layers having the coloring layer 121 interposed therebetween may be configured to have different depths in the vertical direction from each other.

In addition, in this embodiment, the R processing is performed for the outer edges of the upper face and the lower face of the game token 120. Accordingly, it can be prevented that a player's hand handling the game tokens 120 hurts, or the game token 120 damages the other game token 120.

In addition, in this embodiment, the RFID 125 is tightly fixed between plastic layers each forming one of the coloring layer 121 and the white layer 122 or the thin-color layer.

In addition, in this embodiment, on the upper face and/or the lower face of the game token 120, face codes using UV emission ink, infrared absorption ink such as ink (carbon black ink) absorbing infrared rays are arranged. In addition, as a modified example of this embodiment, one or both of a security mark and an optical variable device (OVD) may be printed on the surfaces of the game token 120 instead of the face codes or together with the face codes.

In addition, the game token 120 according to this embodiment has a structure in which the side ID 126 is attached to the side face, the RFID 125 is built, and face codes using UV emission ink or infrared absorption ink are arranged on the upper face or the lower face (the print layer 124). Then, the information of a side ID 126 and the information of an RFID 125 are associated with each other, the information of a side ID 126 and information of a face code are associated with each other, or the information of a side ID 126, information of an RFID 125, and the information of a face code are associated with each other.

In addition, the inspection device 200 according to this embodiment includes: the measurement device 19 of the type of game token 120 that images the side face of the game token 120 and determines the color of the stripe pattern of the side face in the stacking direction; and the mark reading device 205 that reads the print of the game token. In this way, a relation between the type of game token and the content of a print can be inspected.

The management control device 14 according to this embodiment performs imaging for determining the position, the types, and the quantities of game tokens placed by a game participant in each game when the first card is drawn from the card distributing device 3, before and after drawing, or after a dealer's sign representing the end of betting.

In addition, the game token 120 according to this embodiment is manufactured as below. First, a stacked structure body including a plurality of plastic layers is formed by heating and pressing the coloring layer 121 and the white layers 122 or the thin-film layers. Then, a drawing pattern is printed at least on the upper face or the lower face of the stacked structure body, whereby a game token original plate is generated. Then, punching processing is performed for the game token original plate by using a mold, whereby a plurality of game tokens having a predetermined shape are acquired. Here, at the time of punching processing, R processing is performed for the outer edges of the upper and lower faces of the game token 120 by using a mold.

In addition, in a case where game token 120 having side IDs is to be manufactured, side IDs are printed on the side faces of the white layers 122 or the thin-color layers through inkjet printing. Furthermore, in a case where game token 120 including an RFID is to be manufactured, an RFID is interposed between the layers of the stacked structure body, and the layers having the RFID interposed therebetween are heated and welded when the layers are thermos-compressed, whereby the periphery of the RFID is tightly fixed by the plastic layers.

In addition, the management system of table games according to this embodiment includes: the card distributing device 13 that determines and displays a result of winning/losing of each game in the game table 4; the camera device 2 that images game tokens 120 placed on the game table 4; and the management control device 14 that specifies and stores the position, the types, and the quantities of game tokens placed by the game participant 6 on the game table 4 by using a result of the imaging performed by the camera device 2. The game tokens 120 are a stacked structure body in which the coloring layer 121 and the white layers 122 or the thin-color layers are stacked and has a stripe pattern on the side face in the stacking direction. The management control device 14 has a calculation function calculating a balance of the casino side in the game table 4 for each game based on a result of winning/losing acquired from the card distributing device 13 and the position, the types, and the quantities of the game tokens 120 specified using the imaging result of the camera device 2.

The management control device 14 has a function of measuring the number of the coloring layers 121 or the white layers 122 or the thin-color layers of game tokens 120 placed by each game participant 6, determines the types and the amounts of the game tokens by using the colors of the coloring layer 121, and determining the quantities of the game tokens 120.

A system according to a third embodiment relates to a game token management system preventing the use of fake game tokens in a game house in a casino or other game facilities using game tokens.

Among many live table games played in a casino or a game facility, there are Baccarat and blackjack. In such games, a standard deck configured by 52 playing cards is used, and playing cards are distributed to a game table from a shooter including a plurality of decks (6 to 9 decks or 10 decks) shuffled in advance, and a game is played. In a casino or a game facility, game tokens are used for such games.

The use of fake game tokens should not occur in a casino. In order to prevent the use of fake game tokens in a casino, there is a technology for preventing the use of fake game tokens by attaching an RFID to game token. The RFID-attached game tokens are known and is disclosed in WO 2008/120749 A.

This embodiment provides a management system or a game token preventing the use of fakes game token used in a casino or a game facility, and the use and unjust exchange of fake game token in a casino or a game facility can be prevented. In recent years, the technologies for manufacturing fake game token evolve, and technologies advance up to a level of copying an authenticity determination mark or an RFID almost perfectly. As a result, a mark or an RFID that is the same as a genuine authenticity determination mark or a genuine RFID is attached to game token, genuine and fake game token cannot be discriminated from each other, and there is a problem in that it is almost impossible to perform an authenticity determination.

In order to solve the conventional problem described above, a game token management system according to this embodiment includes: a game token to which a side ID that can be individually identified is attached; an ID reading device that reads a side ID attached to the game token; a storage in which the game tokens are stored in a cashier of a game house; a game table game token tray that stores the game tokens; a game token determining device that specifies types and quantities of the game tokens stored in the game table game token tray and the storage by using the ID reading device; and a management control device that manages the IDs associated with the game tokens in a database. The management control device has functions of registering the IDs of the game tokens to be used in the database in advance, managing the IDs of the game tokens present at least in the game table game token tray and the storage in the database together with presence information by using the database, specifying the game tokens in the game table game token tray and the storage at predetermined timing, searching the database, determining the following events through the database search 1) an ID not present in the database is newly present 2) two or more same IDs are present, and generating an error signal when a situation of 1) or 2) described above is present.

In addition, the management control device has functions capable of, when there is a change in the presence of the game tokens at least in the game table game token tray and the storage, recording time or a place at which there is the change in the database in association with the ID, searching the database, when there is a situation in which two or more same IDs are present, extracting the ID and information of time or a place recorded in association with the ID in the database from the database and storing extracted information, and specifying time when the game token to which the ID is attached, which is detected first, enters/exits the game table game token tray or the storage or a place of the game table game token tray or the storage in which the game tokens are stored.

Furthermore, the game token management system may further include: a bet area game token determining device specifying the types and quantities of the game tokens bet on a bet area of the game table by using the ID reading device and may have functions of determining the following events through a search of the database also for the ID of the game token present in the bet area of the game table 1) an ID that has not been present in the database is newly present 2) presence of two or more same IDs and generating an error signal when there is a situation of 1) or 2) described above.

In addition, side IDs are attached to at least three positions on the side face of the game token. The side IDs are attached through inkjet printing by using ink that is visible using visible light. Particularly, a configuration is advantageous in which the side ID is attached as presence/absence of marks of a plurality of rows and a plurality of columns. In addition, transparent coating layers or varnish is disposed on the upper and lower faces of the game token.

In order to solve the conventional problems, a game token according to this embodiment forms a stripe pattern on the side face in the stacking direction by employing a multi-layer structure in which a plurality of plastic layers having different colors are stacked, a coloring layer is included at least in one layer, white layers or thin-color layers are stacked on a further outer side than the coloring layer and has a configuration enabling the type of the game token to be specified by the coloring layer. In addition, side IDs are attached to at least three positions on the side faces of the white layers and the thin-color layers, and the type and the manufacturing information of game token can be specified by reading the ID by using the ID reading device, and a configuration in which the ID can be managed in a database is included. Then, the side ID may be attached using ink (visible ink) that is visible for visible light through inkjet printing. The side ID may be attached using ink (ink absorbing infrared rays, UV ink, or the like) that is not visible for visible light through inkjet printing. In addition, the side ID may be printed using at least two or more of ink that is visible for visible light, ink absorbing infrared rays, and UV ink.

In order to solve the conventional problems described above, a game token according to this embodiment has a side ID that can be individually identified attached thereto, the side ID attached to the game token is read by an ID reading device, the ID reading device can read the game token stored in a storage maintained by a cashier of a game house and a game token tray of a game table, in addition, the types and the quantities of the game tokens stored in the game token tray and the storage are specified by a game token determining device through the ID reading device, the ID of the game token present in the game token tray of the game table and the storage is managed in the database together with the presence information thereof, it is inspected whether at least 1) an ID that has not been present in the database is newly present and 2) two or more same IDs are present, and the ID enabling the occurrence of the situation 1) or 2) described above to be determined is included.

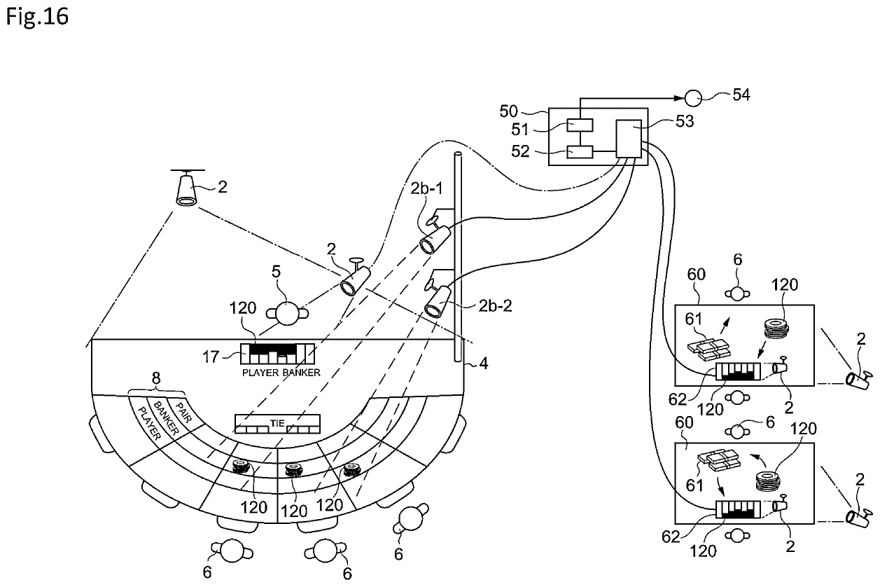

Hereinafter, a game token management system in a game house including a game table according to an embodiment of the present invention will be described with reference the drawings. FIG. 16 is a diagram that illustrates an overview of the whole system. The game token management system in a game house including a plurality of game tables 4 (only one game table is illustrated in FIG. 16) images the state of progress of a game played in the game table 4 including a game participant 6 and a dealer 5 through a plurality of camera devices 2 and stores and manages the state. Particularly, the game token management system specifies the types and the quantities of game tokens 120 used in the game table 4 by analyzing image information acquired by the camera device 2. A side ID 126 is attached to the side face of the game token 120, and the types and the quantities of the game tokens 120 is acquired by determining the side ID 126 and reading the types and the quantities. In addition, in this specification, a description of “side ID” or “ID” is used not only in the meaning of an ID as a physical entity attached to the side face of the game token 120 but also in the meaning of identification information represented thereby. An ID reading device 53 disposed inside a management control device 50 connected to the camera device 2 specifies a side ID 126 by analyzing image information acquired from the camera device 2. Particularly, the management control device 50 includes a game token determining device 52 specifying the types and the quantities of the game tokens 120 that is in a horizontally aligned state or in a piled state based on a result of the reading of the side ID 126 acquired by analyzing the image data imaged through the camera device 2 therein.

In addition, the management system according to this embodiment is configured to image game tokens 120 disposed on a game table 4 by using a plurality of camera devices 2b-1 and 2b-2, which have different heights, arranged at predetermined positions in addition to the camera device 2 that images the game tokens 120 and records an acquired image. The camera device 2b-1 can image game tokens 120 disposed at a relatively far position on the game table 4, and the camera device 2b-2 is configured to image game tokens 120 disposed relatively close on the game table 4. By performing imaging the two camera devices 2b-1 and 2b-2, game tokens 120 disposed at a place that is in a blind area for one of the camera devices can be imaged as well.

In a plurality of cashiers 60 present in a game house, the game tokens 120 are exchanged with cash 61 paid by a game participant 6, and, in each cashier 60, game tokens 120 are stored in a storage 62 storing the game tokens 120. In each cashier 60 of a game house, game tokens 120 brought by a game participant 6 are refunded into cash 61. In the game table 4, game tokens 120 are stored in a game table game token tray 17, and a dealer 5 collects game tokens 120 bet by a game participant 6 who has lost the game from the table 4 in each game, returns the collected game tokens 120 to the game table game token tray 17, and then re-pays the game tokens 120 to a game participant 6 who has won each game. All such exchanges between a game participant 6 and a cashier 60 of a game table or a dealer 5 are imaged and recorded by all the camera devices 2. In the storage 62 or the game table game token tray 17, when there is exchange of game tokens 120 with a game participant 6, the game tokens 120 stored in the storage 62 or the game table game token tray 17 increases or decreases. The types and the quantities of the game tokens 120 stored in the game table game token tray 17 and the storage 62 are monitored at predetermined timing or constantly by the ID reading device 53 and the game token determining device 52 through the camera device 2. The management control device 50 stores the side IDs 126 of all the game tokens 120 assumed to be used in a game house in the database 51 in advance (the side IDs 126 of all the game tokens 120 assumed to be used in the game house are registered).

In addition, also in this embodiment, the game token tray 17, as illustrated in FIGS. 14A and 14B, may be configured by an upper game token tray 17a and a lower game token tray 17b of upper/lower two stages. In such a case, in the state illustrated in FIG. 14A, the upper game token tray 17a can be imaged by the camera device 2, and, in the state illustrated in FIG. 14B, the lower game token tray 17b can be imaged by the camera device 2. In the state illustrated in FIG. 14B, additionally, the upper game token tray 17a and the lower game token tray 17b can be imaged by the camera device 2c simultaneously and also in an individually-identifiable state. In addition, in the state illustrated in FIG. 14B, the upper game token tray 17a and the lower game token tray 17b may be separately imaged. Each of the camera devices 2 and 2c may include a single visible-light camera or a single infrared ray camera corresponding to ink printed for the side ID 126 or a camera capable of performing switching among a plurality of functions of a visible-light camera and an infrared-ray camera corresponding to the printed ink.

In this way, in the game house, by using the database 51, the management control device 50 managing the side IDs 126 associated with game token 120 manages all the side IDs 126 of at least game tokens 120 present in the game table game token tray 17 and the storage 62 in the database 51 together with the presence information thereof (the storage 62, the game table game token tray 17, in the middle of moving from a backyard (not illustrated in the drawing), held by a game participant 6, or the like). The management control device 50 specifies all the game tokens 120 disposed in the game table game token tray 17 and the storage 62 by using the side IDs 126 at predetermined timing or constantly, searches the database 51, and determines the following events through the search of the database 51:1) A side ID 126 that has not been present (or not present) in the database 51 is determined to be newly present; and 2) Two or more same IDs are determined to be present.

The management control device 50 has a function of generating an error signal representing an abnormality and giving a notification to a management division or a security division 54 of the game house when the situation of 1) or 2) described above is present. The management control device 50 specifies all the game tokens 120 disposed in the game table game token tray 17 and the storage 62 at predetermined timing or constantly by using the side IDs 126 and stores all the game tokens 120 in the database 51 and thus, can determine that 1) a side ID 126 that has not been present (or not present) in the database 51 is newly present and 2) two or more same IDs are present.

In addition, when there is a change in the presence of the game tokens 120 at least in the game table game token tray 17 and the storage 62, the management control device 50 records time or a place (the storage 62, the game table game token tray 17, or the like) at which the change is present in the database 51 in association with the side ID 126 and, as a result of the search of the database 51, when there is a situation in which two or more same side IDs 126 are present, extracts the side ID 126 and information of time or a place recorded in the database 51 in association with the side ID 126 from the database 51 and stores the side ID and the information that have been extracted, and thus, time at which game token 120 to which the side ID 126 is attached, which has been detected first (used first or cashed), enters/exits the game table game token tray 17 or the storage 13 or a place of the game table game token tray 17 or the storage 13 in which the game tokens 120 are stored can be specified by using the database 51. When the time and the place can be specified, a suspicious person for the use of unjust game tokens 120 or the like can be specified from the recorded video of the camera device 2.

In this game token management system, the management control device 50 can specify the types and the quantities of the game tokens 120 bet on the bet area 8 of the game table 4 by using the ID reading device 53. The game tokens 120 of the bet area 8 are imaged by the camera device 2b that particularly images the bet area 8 and, also for the side ID 126 of the game token 120 present on the bet area 8 of the game table 4, determines the following events by searching the database 51:1) A side ID 126 that has not been present in the database 51 is newly present in the bet area 16; and 2) Two or more same IDs are present.

The management control device 50 has a function of generating an error signal when a situation of 1) or 2) described above is present.

The management control device 50 of this system, the ID reading device 53 disposed inside, and the game token determining device 52 specifying the types and the quantities of game tokens 120 have a structure integrally including a computer formed as one body or by a plurality of configurations, a program, and a memory.

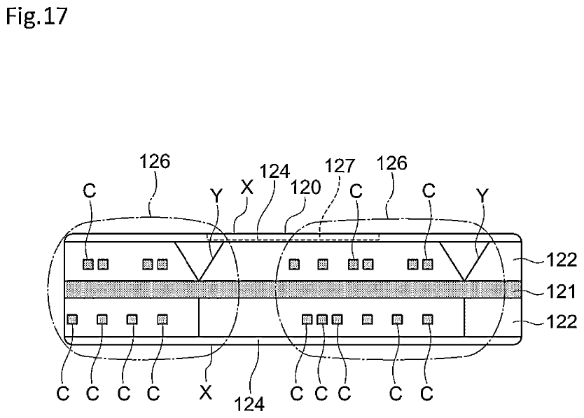

Next, details of game token 120 (so-called substitute currency for gaming) used in this system will be described. FIG. 17 is a side view of game token 120 used in this system, the game token 120 is formed by stacking a plurality of plate-shaped plastic layers having different colors, forming the plastic layers to be integrated using a means of thermo-compressing or the like, and then, punching holes in the shapes of circles and quadrangles. The game token 120 manufactured in this way has a multi-layer structure in which a coloring layer 121 is included at least in the middle, and white layers 122 or thin-color layers (may be layers of a color thinner than that of the coloring layer 121; not illustrated in the drawing) are stacked on both sides (in FIG. 17, the upper and lower sides) of the coloring layer 121 disposed in the middle. In this way, by employing the multi-layer structure in which the coloring layer 121 is included, and the white layers 122 or the thin-color layers (may be layers of a color thinner than that of the coloring layer 121; not illustrated in the drawing) are stacked on both sides of the coloring layer 121 disposed in the middle, as illustrated in FIG. 17, a stripe pattern (in the stacking direction) when seen from the side face is formed, and, by changing the color (red, green, yellow, blue, or the like) of the coloring layer 121 for each type (10 points, 20 points, 100 points, 1000 points, and the like) of the game token 120, the type of the game token 120 can be specified.

In addition, as illustrated in FIG. 17, in the game token 120, a side ID 126 representing the type of game token 120 is applied to the side faces of the white layers 122.

In the outermost layers, transparent layers 124 are arranged, and each interlayer is thermo-compressed to form a structure of at least five layers. Such game token 120 is formed by using a plastic material having a thin long shape, and layers (at least the coloring layer 121 and the white layers 122) are thermo-compressed to form a closely adhering state (the structure of five layers or the like) in the state of a long length, and thereafter, holes having a circular shape, a rectangular shape, or the like are formed therein through press or the like.

When a hole is formed through the press, die of mold for punching, and the size of punching are designed, and R processing (round angle) is performed for the ends of the transparent layer 124 of the outermost layer.

The transparent layers 124 may be a coat layer of varnish. The side ID 126 is attached to at least three positions on the side face of the game token 120. The side ID 126 is attached through inkjet printing using ink that is visible for visible light.

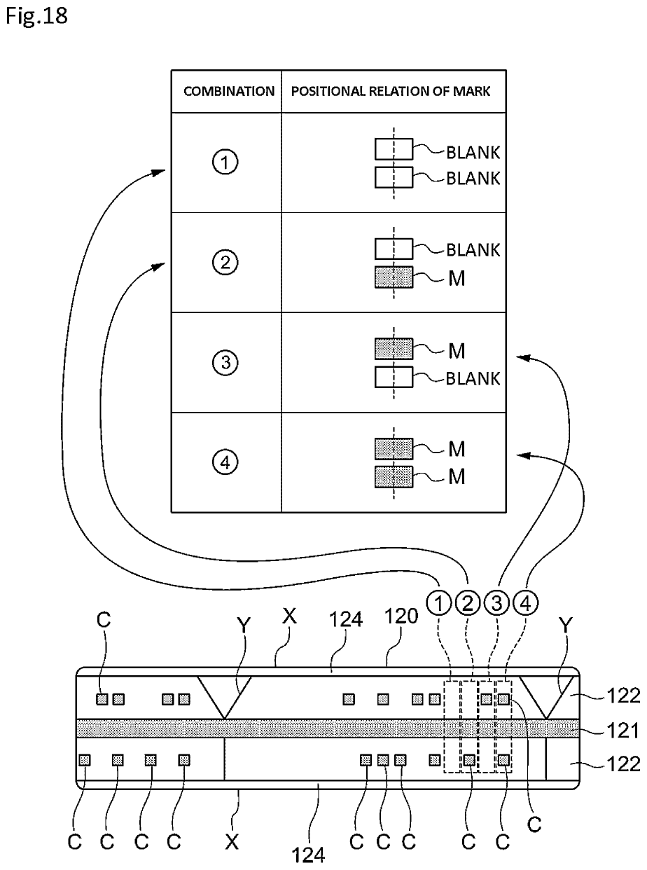

Particularly, in this embodiment, the side ID 126 is configured to be attached as presence/absence of marks C of a plurality of rows and a plurality of columns. In the marks C of the plurality of rows and the plurality of columns, as illustrated in FIG. 17, upper and lower marks C are paired to configure a code, and a code of ten digits is formed in the case illustrated in FIG. 17. A configuration in which upper and lower marks C are paired to configure a code (four types) is illustrated in FIG. 18. A letter “Y” disposed to the side of marks C is an identification mark used for identifying upper and lower sides of a mark. A code configured by marks C is configured to specify a predetermined combination of marks C. As a result, in the example illustrated in FIG. 18, there are four types of combination of the marks C of upper and lower two columns, and, by printing these in ten columns, four to the power of 10 codes can be configured. Since there are four types of a 10-digit code, 4 to the power of 10 codes are acquired, and accordingly, the side IDs 126 of game token 120 can be sufficiently assigned.

The game token 120 forms a stripe pattern on the side face in the stacking direction by employing a multi-layer structure in which a plurality of plastic layers having different colors are stacked, the coloring layer 121 is included at least in one layer, the white layers 122 or the thin-color layers are stacked on a further outer side than the coloring layer 121 and has a configuration enabling the type of the game token 120 to be specified using the coloring layer 121. The side IDs 126 are disposed at least three positions (preferably, six positions) on the side face of the white layer 122 or the thin-color layer, and, in this example, six side IDs are disposed at a predetermined interval of 60 degrees in the rotation direction (circumferential direction). The side IDs 126 individually identifiable (different for each one) are attached to game token 120, and the side IDs 126 are disposed at a predetermined interval of 60 degrees in the rotation direction (circumferential direction) such that the side ID is necessarily seen from the lateral side. The side IDs 126 attached to the game token 120 are read by the ID reading device 53 described above. The type, the manufacturing information, and the like of game token 120 can be specified by reading the side ID 126 by using the ID reading device 53, and a configuration in which the side ID 126 can be managed in the database 51 is formed. In this embodiment, the side IDs 126 are attached using ink (visible ink) that is visible for visible light through inkjet printing. The side IDs 126 may be printed using at least one or a combination of ink (ink absorbing infrared rays) that is not visible for visible light and ink (including a side ID that is very small and is difficult to see) that is visible for at least visible light. In addition, the side IDs 126 may be printed by combining a plurality of such ink of a plurality of types. The ID reading device 53 includes at least a plurality of cameras (that is, a visible-light camera in a case where ink is visible ink, an infrared-ray camera in a case where ink is infrared reactive ink, and an ultraviolet camera in a case where ink is UV ink (UV radiator and a visible-light camera)) corresponding to the ink used for printing the side ID 126 or includes a camera capable of performing switching among a plurality of functions of cameras (a visible-light camera, an infrared ray camera, and an ultraviolet ray camera (an UV radiator and a visible-light camera or the like)) corresponding to the ink.

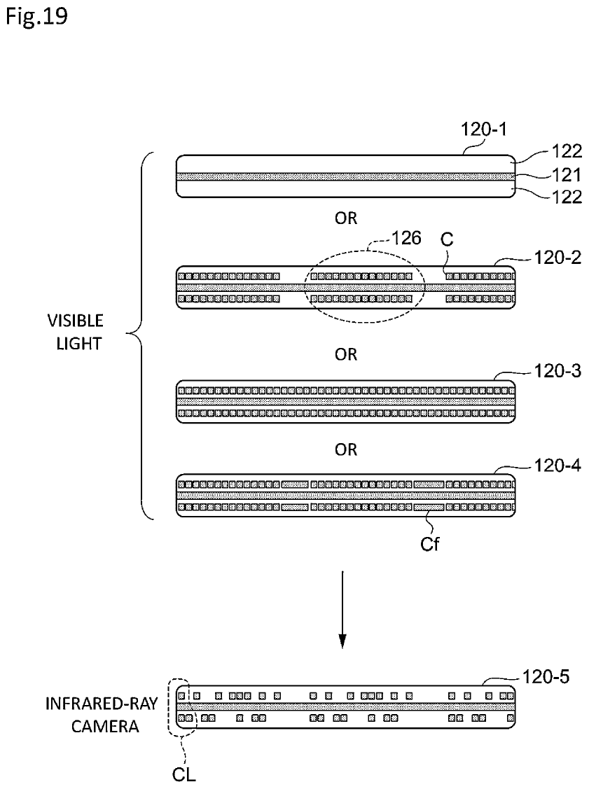

In the case illustrated in FIG. 19, in game token 120-1, side IDs 126 are printed using ink (ink absorbing infrared rays) that is not visible for visible light. In game token 120-2, marks C of a plurality of rows and a plurality of columns are printed using ink that is seen dark for visible light. In game token 120-3, additionally, marks C are printed using ink seen dark for visible light also between the side IDs 126, and the side IDs 126 are configured to dissolve in the design not to be visually distinguished. In game token 120-4, a start point and an end point of the side ID 126 are represented by a mark Cf representing the end. When the game tokens 120-1 to 120-4 are seen using an infrared-ray camera, ink absorbing infrared rays absorbs infrared rays to be seen dark, and the game tokens 120-1 to 120-4 can be imaged in a state (represented as the game token 120-5) in which the side ID 126 can be read. In addition, the upper and lower sides of the side ID 126 are illustrated using a mark CL representing the upper and lower sides. A relation between the upper and lower sides of the mark is as illustrated in FIG. 17. In addition, the side IDs 126 may be printed using a combination of ink that is visible for visible light and an infrared ray absorption ink.

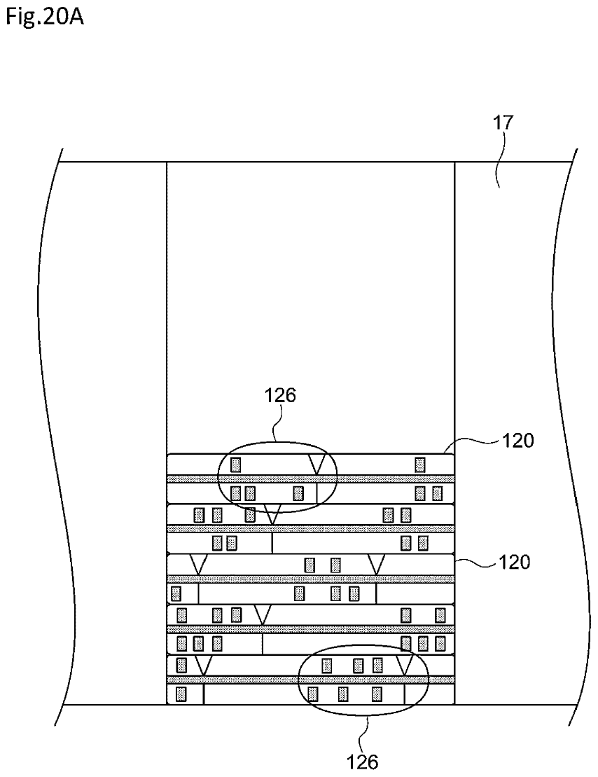

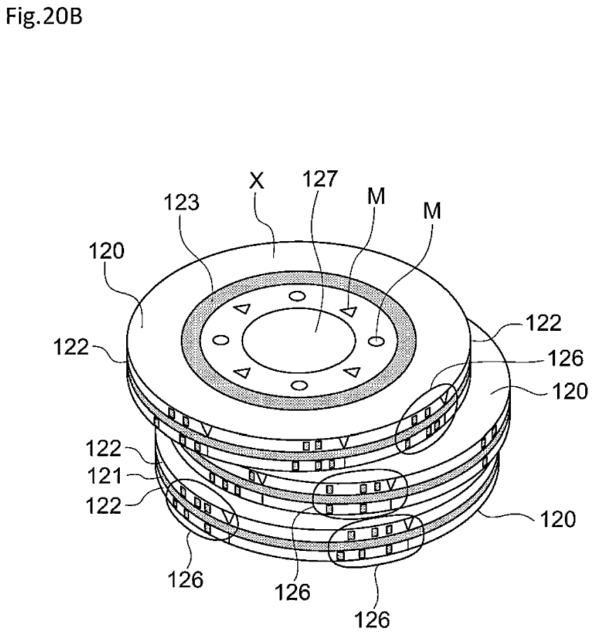

The side IDs 126 attached to the game token 120 are read by the ID reading device 53 described above, and the ID reading device 53 can read the game tokens 120 held in the storage 62 of a cashier of a game house and the game table game token tray 17 of the game table, and actually, as illustrated in FIG. 20A, when the game tokens 120 are stacked horizontally, the side IDs 126 can be read. In addition, the game tokens 120 stacked in the bet area 8 or the like, as illustrated in FIG. 20B, can be also read.

Furthermore, in the game token 120, a face code using UV ink or ink (carbon black ink) absorbing infrared rays is arranged on the surface (X) of the white layer 122 (see FIG. 9B).

This face code represents authenticity of game token 120, and, when ultraviolet rays (or infrared rays) hit the face code, the face code becomes visible to the eyes and represents authenticity based on a combination of the forms and a number. While the transparent layers (print layers) 124 are thermos-compressed or coated in the outermost layers to cover a print 123 (100 points or the like) used for specifying a game house and a face code disposed on the surface, embossing process or varnish processing is performed for the transparent layers 124, and the game token 120 is prevented from adhering to each other and is caused to slide well. In the game token 120, a circular recess 127 is arranged at the center of each of the upper and lower faces.

According to the recesses 127, the game token 120 is prevented from being adhere to each other, and, by increasing the diameter of the recesses 127, the game token 120 can slide well.

The R processing (R) is performed for the ends of the transparent layers (print layers) 124 of the outermost layers for which a print 123 (100 points or the like) is performed, and, in the punching process of the game token 100, the surfaces of the white layers 122 are prevented from being deformed to appear on the side face. In addition, it is prevented that a sharp end remains in the game token 100 and damages the hands or the other game token 120. The coloring layer 121 may be formed by colored one layer or a plurality of layers. In addition, metal or ceramic used for increasing the weight may be built in a layer included in the layer of the coloring layer 121. More specifically, in the material of the layer included in the layer of the coloring layer 121, for example, metal powders (for example, a metal oxide of one or a plurality of metal oxides of zinc oxide and titanium oxide) may be contained. In addition, a part of the coloring layer 121 is hollowed out, or a space is arranged between the coloring layer 121 and the white layer 122, and an RFID may be built therein. In such a case, as the side ID 126 of the game token 120, a side ID 126 according to a code using the marks C and a side ID using the RFID are used together.

In the game token 120 configured in this way, the types and the quantities of the game tokens 120 that is held in the game table game token tray 17 and the storage 62 are specified by the game token determining device 52 through the camera device 2 and the ID reading device 53, and the side IDs 126 of the game tokens 120 present on the game table game token tray 17 and the storage 62 are managed in the database 51 together with the presence information thereof. In this way, at least, it is inspected whether 1) a side ID 126 that has not been present in the database 51 is newly present 2) two or more same side IDs 126 are present. By determining the occurrences of the situations of 1) and 2) described above by searching for all the side IDs 126, the inspection is realized.

As described above, while a game participant 6 can perform exchange of cash 61 for game tokens in the cashier 60, exchange of cash 61 for game tokens 120 can be performed also in the game table 4. The camera device 2 images bills placed on the game table 4 to exchange them for game tokens 120. That is, a plurality of camera devices 2 imaging the game tokens 120 disposed on the game table 4 are arranged at different positions to have different heights.

The management control device 50 specifies the types and the quantities of game tokens 120 to be discharged from the game token tray 17 in the exchange from bills by using a result of imaging of bills using the camera device 2. The management control device 50 compares real total amounts of the game tokens 120 housed in the game token tray 17 before and after the payment and determines whether or not this difference corresponds to the specified types and quantities of the game tokens 120 to be discharged.

That is, the management control device 50 determines through a comparison whether or not a total amount of the game tokens 120 perceived in the game token tray 17 corresponds to an increase/decrease according to a paid amount of the game tokens 120 corresponding to exchanged bills after the exchange of the bills and the game tokens 120. In addition, when collection and re-payment according to a result of winning/losing of a game are simultaneously performed, the management control device 50 determines through a comparison whether or not the total amount corresponds to an amount of the game tokens 120 bet by all the players 6 and an increase/decrease in the game tokens 120 calculated based on a result of the winning/losing of the game.

Here, the management control device 50 is a control device having an artificial intelligence-utilizing or deep-learning structure capable of acquiring information of the types and the quantities of the game tokens 120 even in a state in which a part or whole one unit of the game tokens 120 is hidden when the types and the quantities of the game tokens 120 are measured and determined.

As described above, the side IDs 126 are attached to the white layers 122 or the thin-color layers of the side face of the game token 120 at least at three or more positions spaced apart in a rotation direction (circumferential direction). The types and the manufacturing information of game token 120 can be specified by reading the side IDs 126 by using the ID reading device 53. The specified information specified through measurement has a configuration that can be collated and managed with the database 51.

The management control device 50 may be a control device having an artificial intelligence-utilizing or deep learning structure. The management control device 50 can perceive the position 8 (a position betting on a player, a banker, or a pair), the types (a value of a different amount is assigned to the game token for each color), and the quantities of the game tokens 120 by using an artificial intelligence-utilizing type computer or control system, a deep-learning (structure) technology, a self-learning function, or the like.

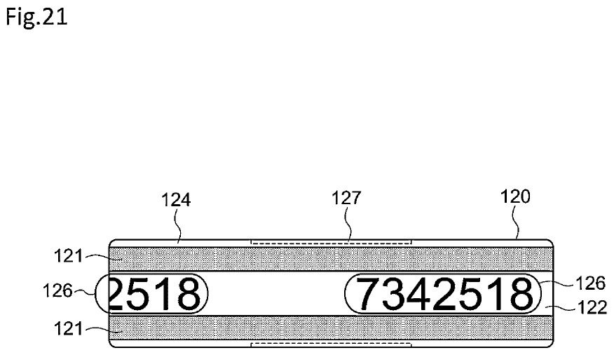

Hereinafter, a modified example of the game token 120 will be described. In the modified example, on the side face of the game token 120, a seven-digit number is printed as the side ID 126. In the example illustrated in FIG. 21, a white layer 122 is disposed in the middle, and, under the white layer, a coloring layer 121 is disposed. A number as a mark is printed on the white layer 122 disposed in the middle and configured a side ID 126. When 10 types of combinations of numbers are printed in seven digits, 10 to the power of 7 codes can be configured, and accordingly, the side IDs 126 of game token 120 can be sufficiently assigned. In the camera device 2 and an image analysis thereof, there are cases where it is difficult to determine and read a number, a combination of marks C described in the previous embodiment is considered to be advantageous in the image analysis.

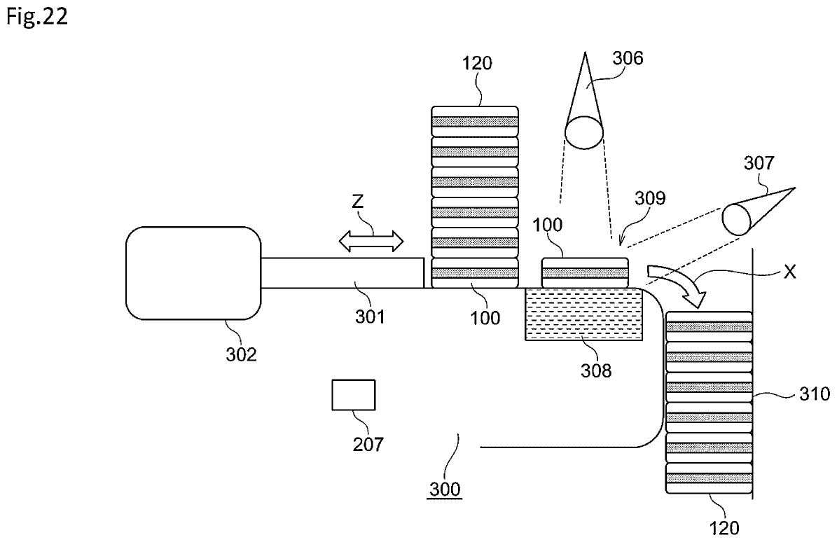

Another inspection device 300 inspecting the game tokens 120 will be described with reference to FIG. 22. The inspection device 300 includes: a face code reading device 306 that reads a face code M formed using UV emission ink or ink absorbing infrared rays disposed on the surface of the game token 120; an ID reading device 307 that reads the side ID 126 of the side face; an RFID reading device 308 that reads information of an RFID (not illustrated in the drawing) of the game token 120; and a control device 207. The control device 207 is configured to inspect a relation among the information of the side ID 126 acquired by the ID reading device 307, the information acquired from the face code reading device 306, and the information acquired from the RFID reading device 308. There is a correct database (not illustrated in the drawing), and the relation among the information is inspected by comparing a reading result with the database. This inspection is used for preventing the occurrence of a defect by detecting a print error in the face code M and the side ID 126 or for discrimination with a fake.

This example (FIG. 22) includes an extrusion device 302 that supplies game tokens 120 one at each time to a reading stage 309 by using an extruder 301 that in moved in the direction of an arrow Z by the extrusion device 302, and the stacked game tokens 120 are supplied from the extrusion device 302 to the reading stage 309. In this way, previous game token 120 for which the inspection is completed is extruded and falls in the direction of an arrow X, and the game tokens 120 that has fallen in the direction of the arrow X are held on a holding stage 310.

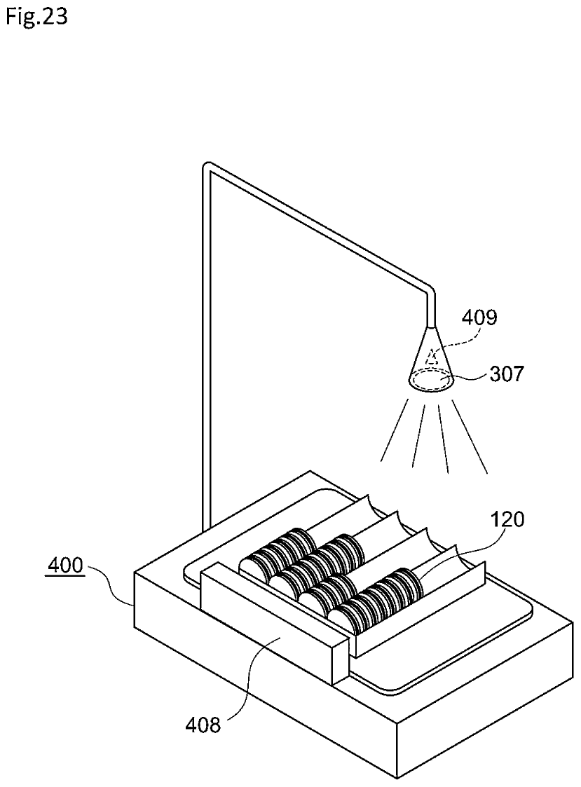

Further another inspection device 400 that inspects game tokens 120 will be described with reference to FIG. 23. The inspection device 400 includes: an RFID reading device 408 that reads information of an RFID (not illustrated in the drawing) of the game token 120; an ID reading device 307 that reads the side ID 126 of the side face; and a control device 207 and is configured to inspect a relation between the information of the side ID 126 acquired by the ID reading device 307 and the information acquired from the RFID reading device 408. There is a correct database (not illustrated in the drawing), and the relation among the information is inspected by comparing a reading result with the database. This inspection is used for preventing the occurrence of a defect by detecting a print error in the face code M and the side ID 126 or for discrimination with a fake.

The ID reading device 307 includes a single visible-light camera or a single infrared-ray camera corresponding to ink used for print the side ID 126 and is configured to include a camera 409 capable of performing switching among a plurality of functions of a visible-light camera and an infrared-ray camera corresponding to the printed ink. The visible-light camera can read the number and the color of the game token 120, and the infrared-ray camera can read the side ID 126 of the game token 120.

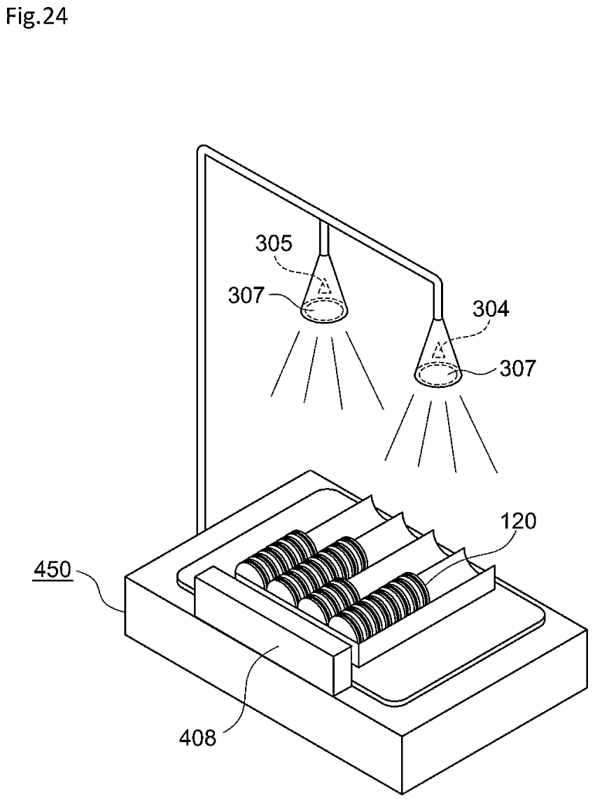

Still another inspection device 450 inspecting game tokens 120 will be described with reference to FIG. 24. A same reference numeral is assigned to a same component as that of the inspection device 400 (the description thereof will not be presented). An ID reading device 307 is configured to include a plurality of visible-light cameras 304 or infrared-ray cameras 305 corresponding to ink used for printing the side ID 126. The visible-light camera 304 can read the number and the color of the game token 120, and the infrared-ray camera 305 can read the side ID 126 of the game token 120.

A management control device 50 acquires a total amount of game tokens (chips) placed in a game token tray 17 after a settlement at the time of the end of a game through a game token determining device 52. A determination of “after a settlement” is when any one of the following 1) to 4) occurs: 1) when re-payment for winning game tokens 120 (winning chips) is completed; 2) when cards C used in this game are collected and are disposed in a disposal area or a disposal slot of the table; 3) when a predetermined button accompanying a card distributing device 3 functioning as a winning/losing result determining device is pressed; and 4) when a marker 43 representing winning/losing is returned to the original state

In addition, in this embodiment, an image analyzing device 18 according to the second embodiment that records a state of process of a game played in the game table 4 as a video including game participants 6 and a dealer 5 through a plurality of camera devices 2 and performs an image analysis of the recorded video of the state of process of the game to analyze and perceive a total amount of the game tokens 120 in the game token tray 17 of a dealer 5 of the game table 4 and a measurement device 19 that performs an analysis and measurement by using information acquired by the image analyzing device 18 and determines the types and the quantities of the game tokens 120, and/or a mark reading device 205 that reads a face code formed using UV emission ink or ink absorbing infrared rays disposed on the surface of the game token 120 are combined, and an RFID reading device 308 that reads information of an RFID 125 of the game token 120 is combined as is necessary, whereby an inspection device as below including a management control device 50 can be configured.

That is, by combining the RFID reading device 308 reading the information of the RFID 125 of the game token 120 with the configuration described above, an inspection device including the ID reading device 53 reading the side ID 126 of the side face and the management control device 50 can be configured. In this inspection device, the management control device 50 inspects a relation between the information of the side ID 126 read by the ID reading device 53 and the information of the RFID 125 read by the RFID reading device 308 is inspected.

In addition, by combining the mark reading device 205 of the second embodiment that reads a face code formed using UV emission ink or an infrared-ray absorption ink arranged on the upper face or the lower face of the game token 120 with the configuration described above, an inspection device including the ID reading device 53 reading the side ID 126 of the side face and the management control device 50 can be configured. In this inspection device, the management control device 50 inspects a relation between the information of the side ID 126 read by the ID reading device 53 and the information of the face code read by the mark reading device 205.

In addition, by combining the mark reading device 205 of the second embodiment that reads a face code formed using UV emission ink or an infrared-ray absorption ink arranged on the surface of the game token 120 and an RFID reading device 308 reading information of the RFID 125 of the game token 120 with the configuration described above, an inspection device including the ID reading device 53 reading the side ID 126 of the side face and the management control device 50 can be configured. In this inspection device, the management control device 50 inspects a relation among the information of the side ID 126 read by the ID reading device 53, the information of the face code read by the mark reading device 205, and the information of the RFID 125 read by the RFID reading device 308.

As described above, in this embodiment, in the game token 120, side IDs 126 used for identifying each individual is attached to the outer faces of the white layer 122 or the thin-color layer.

The side IDs 126 are attached to at least three or more positions spaced apart in a rotation direction (circumferential direction) of the game token 120.

In addition, the side IDs 126 are printed using non-visible ink (for example, infrared-ray absorption ink or UV emission ink) that is not visible for visible light.

Furthermore, the side IDs 126 are disposed in a plurality of rows on the side faces of two layers of the white layers 122 or the thin-color layers.

In addition, at least one layer among the plurality of plastic layers configuring the coloring layer 121 and the white layers 122 is a layer containing metal powders (for example, a metal oxide of one or a plurality of metal oxides of zinc oxide and titanium oxide) used for increasing the weight in the layer.

In addition, the side IDs 126 may be printed using at least two or more types of ink among ink that is visible for visible light, an infrared-ray absorption ink, and UV ink. In such a case, the ID reading device 53 includes a plurality of cameras corresponding to each ink used for printing the side IDs 126 or includes a camera capable of performing switching among a plurality of imaging functions corresponding to each ink.

In addition, the game token 120 is manufactured as below. First, a coloring layer 121 and white layers 122 or thin-color layers having the coloring layer 121 interposed therebetween are thermos-compressed, whereby a stacked structure body including a plurality of plastic layers is formed. Then, drawing patterns are printed on at least the upper face or the lower face of the stacked structure body, whereby a game token original plate is generated. Then, punching processing is performed for the game token original plate by using a mold, whereby a plurality of game tokens having a predetermined shape are acquired. Here, in at least one layer among the plurality of plastic layers, a layer containing metal powders or a metal oxide used for increasing the weight is used.

On side faces of the game token 120 manufactured in this way, side IDs 126 used for identifying each individual are printed. At this time, the side IDs 126 may be printed through inkjet printing.

In addition, an RFID 125 is interposed between the layers of the stacked structure body, and the layers having the RFID 125 interposed therebetween are heated and welded when the layers are thermos-compressed, whereby the periphery of the RFID 125 is fixed to be adhering to the plastic layers.

In addition, the management system of table games according to this embodiment includes: a game token tray 17 that is disposed on a game table 4 and holds game tokens 120 for each type; a camera device 2 that images the game tokens 120 held in the game token tray 17; and a management control device 50 that specifies the types and the quantities of game tokens 120 held in the game token tray 17 and measures a total amount of the game tokens 120 disposed on the game token tray 17 by using a result of the imaging performed by the camera device 2.

The game token 120 is a stacked structure body in which the coloring layer 121 and the white layers 122 or the thin-color layers are stacked and has a stripe pattern on the side face in the stacking direction. The management control device 50 has a function of measuring the number of the coloring layers 121 or the white layers 122 or the thin-color layers of the game token placed by each game participant and determining the types and the amount of the game tokens based on the colors of the coloring layers 121.

The management control device 50 determines whether or not a real total amount of the game tokens 120 after the end of a game that is perceived on the game token tray 17 corresponds to an increase/decrease amount of the game tokens 120 calculated based on the amount of the game tokens 120 bet by all the players 6 and a result of winning/losing of the game.

In the management control device 50, the acquisition of the total amount of the game tokens 120 in the game token tray 17 after a settlement at the time of end of a game may be performed at one of: 1) time when re-payment for winning game tokens 120W ends; 2) time when cards used in the game are collected and are disposed in a disposal area of the table; 3) time when a predetermined button accompanying a card distributing device 3 functioning as a winning/losing result determining device is pressed; and 4) time when a marker representing winning/losing is returned to the original state.

The camera device 2 can also image bills place on the game table 4 for exchange of the game tokens 120, and the management control device 50 specifies the types and the quantities of game tokens 120 disposed on the game token tray 17 to be decreased according to exchange of the game tokens 120 disposed on the game token tray 17 and bills by using a result of the imaging of the bills and performs a comparison with a real total amount of the game tokens 120 disposed on the game token tray 17.

The management control device 50 determines through a comparison whether a total amount of game tokens 120 perceived in the game token tray 17 corresponds to an increase/decrease according to a paid amount of game tokens 120 corresponding to exchanged bills after the exchange of the bills and game tokens 120 is performed and an increase/decrease in game tokens 120 calculated based on the amount of game tokens 120 bet by all the players 6 and a result of winning/losing of the game.

The management control device 50 is a control device having an artificial intelligence-utilizing or deep-learning structure capable of acquiring information of the types and the quantities of game tokens 120 also in a state in which a part or one unit of the game tokens 120 is hidden when the types and the quantities of the game tokens 120 are measured and determined.

The side IDs 126 attached to the white layers 122 or the thin-color layers of the side face of the game token 120 at least at three or more positions spaced apart in a rotation direction (circumferential direction), the types and manufacturing information of game token 120 can be specified by reading the side ID 126 by using the ID reading device 53, and the specified information specified through measurement has a configuration that can be collated and managed with the database 51.

The side IDs 126 may be printed using two or more types of ink among ink (visible ink) that is visible for visible light, infrared-ray absorption ink, and UV emission ink. In such a case, the ID reading device 53 includes a plurality of types of cameras (a plurality of types of a visible-light camera, an infrared-ray camera, and an ultraviolet camera (a UV radiator and a visible-light camera, and the like) corresponding to ink used for printing the side IDs 126.

Alternatively, a camera capable of performing switching among a plurality of imaging functions (a visible-light camera, an infrared-ray camera, and an ultraviolet camera (a UV radiator and a visible-light camera, and the like) corresponding to each ink may be included.

In addition, a configuration may be employed in which game tokens 120 disposed on the game table 4 are imaged by using a plurality of camera devices 2b-1 and 2b-2 that are arranged at predetermined positions and have different heights.

In the embodiments described above, while the image analyzing device 12 and the control device 14 are devices having an artificial intelligence-utilizing or deep learning structure, more specifically, the image analyzing device 12 and the control device 14 may perform an image analysis and various control processes described above by using a scale-invariant feature transform (SIFT) algorithm, a convolutional neural network (CNN), deep learning, machine learning, or the like. Such technologies are technologies for recognizing a target included in an image by performing image recognition for a captured image, and particularly, in recent years, a target is recognized with high accuracy by using a deep learning technology having multi-layered neural network.

In this deep learning technology, generally, in an intermediate layer between an input layer and an output layer of a neural network, layers overlap each other over a plurality of stages, and accordingly, a target is recognized with high accuracy.

In these deep learning technologies, particularly, a convolutional neural network has attracted attention owing to high performance according to recognition of a target based on conventional image features.

In the convolutional neural network, a recognition target image to which labels are assigned is learned, and main target included in the recognition target image is recognized. In a case where a plurality of main targets are present in a learning image, a designation is made using an area rectangular, and learning is performed with a label assigned to an image corresponding to the designated area. In addition, in the convolutional neural network, a main target in an image and the position of the target can be determined.

The convolutional neural network will be further described. In a target recognition process, by performing an edge extracting process and the like for a recognition target image, candidate areas are extracted based on local features, and, after feature vectors are extracted by inputting the candidate areas to the convolutional neural network, type is performed, and a candidate area having a classified highest certainty factor is acquired as a result of the recognition.

Here, the certainty factor is an amount representing a relative degree of highness of the similarity of a subject of an image learned together with an image area and a label relative to the similarity of the other classes.

In addition, devices having artificial intelligence-utilizing or deep-learning structures are disclosed in U.S. Pat. No. 9,361,577, US 2016-171336 A, US 2015-036920 A, JP 2016-110232 A, and the like, the content of which is incorporated herein by reference.

When a game concludes, a dealer picks up the game tokens bet by players and pays out the game tokens for the players according to a game result and details of the bets (such as a bet target and a bet amount) of each player. Preferably, whether or not this collection and payout (hereinafter, the collection and the payout will be collectively referred to as “settlement”) has been accurately performed is determined at the time of the settlement to allow the players and the dealer to clearly recognize it.

In this regard, a fourth embodiment provides a system for displaying accuracy of settlement at the time of the game token settlement subsequent to the end of the game.

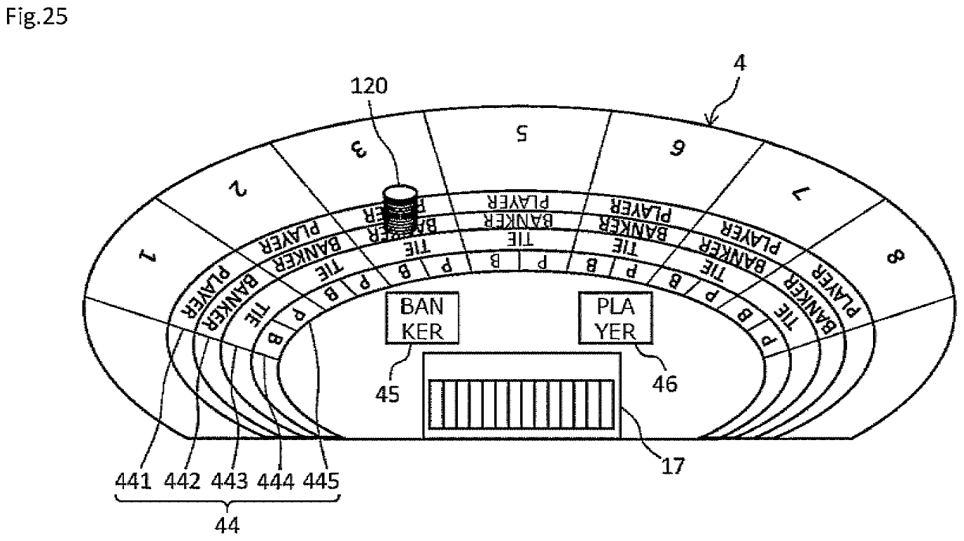

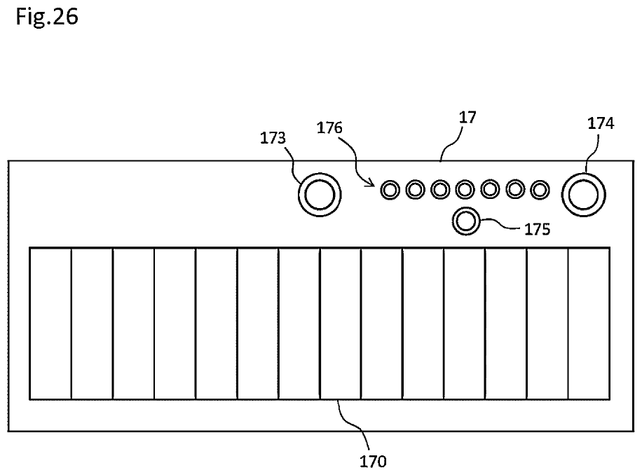

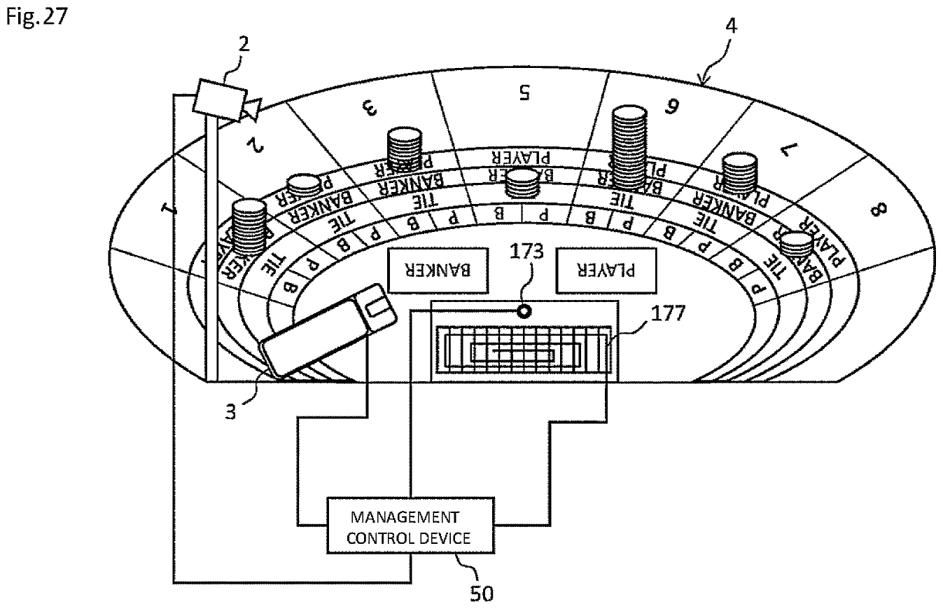

FIG. 25 is a plan view illustrating a gaming table according to this embodiment. FIG. 26 is a plan view illustrating a game token tray according to this embodiment. FIG. 27 is a diagram illustrating a whole configuration of a game token management system including the game token tray. Throughout FIGS. 25 to 29, like reference numerals denote like elements as in the first to third embodiments, and they will not be described repeatedly.

The gaming table 4 is a baccarat table around which respective bet areas 44 are provided for seven players. The bet area 44 of each player includes a player area (PLAYER) 441, a banker area (BANKER) 442, a time area (TIE) 443, a player pair area (P) 444, and a banker pair area (B) 445. Each player performs betting by placing game tokens of the bet amount in a position corresponding to the bet target. In addition, the gaming table 4 includes a player card area 45 where the drawn player cards are placed and a banker card area 46 where the drawn banker cards are placed.

A game token tray 17 for allowing the dealer to store game tokens is provided in front of a dealer position of the gaming table 4. At least a part of the game token tray 17 is buried in the gaming table 4.

The game token 120 used in this embodiment has the same configuration as those of the first to third embodiments. That is, the game token 120 has a symbol, a pattern, or a color by which a type (value) can be identified from each of the front and side faces. In addition, the game token 120 has at least an RFID embedded to store information for identifying the type.

A camera device 2 is provided over the gaming table 4 to photograph the bet area 44. The gaming table 4 according to this embodiment has seven player positions (“1,” “2,” “3,” “5,” “6,” “7,” and “8” in FIG. 25) for allowing participation of seven players. The camera device 2 photographs the bet areas 44 of all player positions. Note that the bet areas 44 of all the player positions may not be photographed by a single camera device 2, or all the bet areas 44 may be photographed by a plurality of camera devices 2 in a distributed manner.

The management control device 50 has all the functions described in the first to third embodiments. The management control device 50 specifies a position (bet target), a type, and the number of the game tokens placed in the bet area on the basis of the image photographed by the camera device 2. A device such as the camera device 2 and the management control device 50 functions as a measurement device or a bet determination device for measuring the position, the type, and the number of the game tokens on the gaming table 4, and its configuration and function are similar to those of the camera device 2 and the image analysis device 12 of the first embodiment.

The card distribution device 3 also has a configuration and a function similar to those of the first embodiment. That is, the card distribution device 3 determines a game winning/losing result on the gaming table 4 and displays it on a result indicator lamp. In addition, the card distribution device 3 transmits the determined game winning/losing result to the management control device 50. The management control device 50 has a function of recognizing the position, the type, and the number of the game tokens on the gaming table 4 and performing a balance count for the casino side on the gaming table 4 using a winning/losing result obtained from the card distribution device 3 as a winning/losing determination device.

On the basis of details of the betting determined from the image of the camera device 2 and the information regarding the winning/losing result obtained from the card distribution device 3, the management control device 50 recognizes, by calculation, the amount of the game tokens to be collected by the casino side on the gaming table 4 in the corresponding game and the amount of the game tokens to be paid out by the casino side, and compares each of them with the amount of the game tokens actually increasing in the game token tray 17 through the collection and the amount of the game tokens actually decreasing in the game token tray 17 through the payout.

The management control device 50 reads the RFID of the game token 120 stored in the game token tray 17 at a predetermined time interval and stores the read information when a change occurs. On the basis of the stored information, the management control device 50 compares the type and the number of the game tokens at the past time point and the type and the number of the game tokens at the current time point, and calculates a change amount of the game tokens 120 in the game token tray 17.

As illustrated in FIG. 26, the game token tray 17 has a storing portion 170 and indicator lamps 173 to 176. The storing portion 170 has a plurality of columns, and each column is configured to store the game tokens by stacking them in a thickness direction. As illustrated in FIG. 27, an antenna 177 is disposed under the storing portion 170.

The indicator lamp 173 displays whether or not a balance between the collected amount and the paid amount is correct. The indicator lamp 174 displays whether or not a total amount of the collected game tokens is correct, and whether or not a total amount of the paid game tokens is correct. The indicator lamp 175 displays whether or not the collection amount or the payout amount of the game tokens bet on the pair is correct.

A total of seven indicator lamps 176 are provided to match the seven player positions. In the collection stage, an indicator lamp 176 corresponding to the player whose game tokens are to be collected (loser in the game) is turned on. In the payout stage, an indicator lamp corresponding to the player who has to get the game tokens (winner in the game) is turned on. Note that, in FIG. 27, only the indicator lamp 173 is illustrated as a representative of the indicator lamps 173 to 176, and the other indicator lamps 174 to 176 are not illustrated for simplicity purpose.

The management control device 50 controls switching on/off operations of the indicator lamps 173 to 176 in order to display the comparison result (match or mismatch). The game token management system according to this embodiment checks whether or not the settlement of the game tokens is appropriately performed in real time using the indicator lamps 173 to 176. The game token management system according to this embodiment also checks, in real time, whether or not a wrongful game token is included in the collected game tokens.

First, the management control device 50 specifies a player who participates in the game on the gaming table 4 and associates the participating player with the player position number (“1,” “2,” “3,” “5,” “6,” “7,” and “8”) of the gaming table 4. Specifically, the management control device 50 can identify a player of each player position using a face authentication system or a membership card.

When a game concludes, the management control device 50 checks the game tokens to be collected by the dealer (winning chips of the casino side) for each player on the basis of the game result, and turns on the indicator lamp 176 corresponding to the player position to be collected. As a result, the dealer can recognize where the game tokens are to be collected out of the player positions.

When a game concludes, first, a dealer picks up all of the game tokens to be collected from the bet area of the loser (collection stage), and then pays out the game tokens for the winner (payout stage). In the collection stage, the dealer stores the game tokens collected from the bet area of the gaming table 4 in the storing portion 170 of the game token tray 17 by checking the indicator lamp 176. Specifically, the dealer stores the collected game tokens in any two right columns serving as a collecting portion in order of the player position number.

Whenever the dealer picks up the game tokens from the bet area 41 and stores them in the collecting portion of the storing portion 170, the management control device 50 determines whether or not the game tokens are collected from the bet area 44 and the amount of the collected game tokens on the basis of the image from the camera device 2. In addition, the management control device 50 determines the amount of the game tokens stored in the collecting portion (increase amount) on the basis of the radio waves received via the antenna 177. Note that, although the two columns of the right side out of fourteen columns serve as the collecting portion of the storing portion 170 in this embodiment, the collecting portion for storing the collected game tokens may be, for example, a horizontal collection game token tray 171 as illustrated in FIG. 13A or a collection game token tray 171 separated from the other columns as illustrated in FIG. 13B.

Here, the management control device 50 obtains, for each player, the increase amount by calculating a difference of the total amount of the game tokens of the storing portion 170 before and after the collection using the RFID. In this manner, the management control device 50 that determines the amount of the game tokens held in the storing portion 170 by reading the information of their types (values) from the RFIDs of the game tokens held in the storing portion 170 corresponds to a dealer chip determination device according to the present invention.

The management control device 50 determines whether or not the actual collection amount determined on the basis of the image from the camera device 2 (image-based collection amount), the increase amount of the game tokens in the collecting portion determined on the basis of the radio wave received from the antenna 177 (RFID-based collection amount), and the collection amount calculated on the basis of the game result and details of the bets of the losers (calculation-based collection amount) match each other.

If the image-based collection amount, the RFID-based collection amount, and the calculation-based collection amount match each other, the management control device 50 turns off the corresponding indicator lamp 176. The dealer can recognize that collection of the game tokens from the players is accurately completed by checking the turn-off state of the indicator lamp 176.

Meanwhile, in a case where the image-based collection amount, the RFID-based collection amount, and the calculation-based collection amount do not match, the indicator lamp 176 remains in the turn-on state. Therefore, the dealer can recognize whether or not the collection of the game tokens from the corresponding player is accurately completed, or whether or not there is a wrongful game token in the collected game tokens.

If the collection of the game tokens described above is completed for all the losers, all the indicator lamps 176 are turned off. At this time point, the management control device 50 determines a total increase amount in the collecting portion using the RFID again, and compares the total increase amount and the total calculation-based collection amount calculated on the basis of the game result and details of bets of all losers. If both amounts match each other, the indicator lamp 174 is turned on.

Here, the management control device 50 calculates a difference between the total amount of the game tokens in the storing portion 170 obtained using the RFID before starting the collection stage after completion of the game and the total amount of the game tokens in the storing portion 170 obtained using the RFID after completion of the collection, in order to obtain a total RFID-based collection amount. The dealer can recognize that the collection of the game tokens is accurately completed by checking the turn-on state of the indicator lamp 174.

Note that the management control device 50 determines whether or not the image-based collection amount determined on the basis of the image from the camera device 2, the RFID-based collection amount determined on the basis of the radio waves received from the antenna 177, and the calculation-based collection amount calculated on the basis of the game result and details of the bets of the losers match each other in aforementioned description. Alternatively, the management control device 50 may determine only whether or not the image-based collection amount matches the calculation-based collection amount or only whether or not the RFID-based collection amount matches the calculation-based collection amount.

In the aforementioned description, the management control device 50 determines a total increase amount using the RFID again if it is determined that the collection is completed for all losers. In addition, the management control device 50 turns on the indicator lamp 174 if the total increase amount matches the total calculation-based collection amount. Alternatively, the management control device 50 may operate as follows. Specifically, the management control device 50 stores the RFID information read whenever there is a change in the amount of the game tokens 120 in the game token tray 17 as described above. In addition, the management control device 50 may determine a total increase amount whenever there is a change in the amount of the game tokens 120 in the game token tray 17 and determine whether or not the total increase amount matches the total calculation-based collection amount. Furthermore, the management control device 50 may turn on the indicator lamp 174 when it is determined that both the amounts match each other.

Next, the dealer pays for the winner (payout stage). If the collection for all of the losers is completed, the management control device 50 turns on the indicator lamp 176 corresponding to the player for which the game tokens are to be paid out. The dealer can recognize the player to be paid out by checking the indicator lamp 176. In the payout stage, the dealer performs the payout by extracting the game tokens corresponding to the payout amount from the storing portion 170 and placing the extracted game tokens on the bet area of the corresponding player.

The management control device 50 determines whether or not the game token is extracted on the bet area and the amount of the extracted game tokens on the basis of the image from the camera device 2 whenever the dealer extracts the game token from the storing portion 170 and places it on the gaming table 4. In addition, the management control device 50 determines the amount of the game tokens extracted from the storing portion 170 (decrease amount) on the basis of the radio waves received via the antenna 177. Here, the management control device 50 obtains, for each player, the decrease amount by calculating a difference of the total amount of the game tokens in the storing portion 170 before and after the payout using the RFID.

The management control device 50 determines whether or not the actual payout amount determined on the basis of the image from the camera device 2 (image-based payout amount), the decrease amount of the game tokens in the storing portion 170 determined on the basis of the radio waves received from the antenna 177 (RFID-based payout amount), and the payout amount of the corresponding winner calculated on the basis of the game result and details of bets (calculation-based payout amount) match each other.

If the image-based payout amount, the RFID-based payout amount, and the calculation-based payout amount match each other, the management control device 50 turns off the corresponding indicator lamp 176. The dealer can recognize that the payout of the game tokens for the corresponding player is accurately completed by checking the turn-off state of the indicator lamp 176.

Meanwhile, if the image-based payout amount, the RFID-based payout amount, and the calculation-based payout amount do not match, the indicator lamp 176 remains in the turn-on state. Therefore, the dealer can recognize that the payout to the corresponding player is not completed.

As the payout of the game tokens for all winners is completed, all the indicator lamps 176 are turned off. At this time point, the management control device 50 determines a total decrease amount in the storing portion 170 using the RFID again, and compares the total decrease amount and the total calculation-based payout amount calculated on the basis of the game result and details of the bets. If both the amounts match each other, the management control device 50 turns on the indicator lamp 174.

Here, the management control device 50 obtains the total RFID-based payout amount by calculating a difference between a total amount of the game tokens in the storing portion 170 obtained using the RFID before starting the payout stage after completion of the collection and a total amount of the game tokens in the storing portion 170 obtained using the RFID after completion of the payout. The dealer can recognize that the payout of the game tokens is accurately completed by checking the turn-on state of the indicator lamp 174.

Note that, in the aforementioned description, the management control device 50 determines whether or not the image-based payout amount determined on the basis of the image from the camera device 2, the RFID-based payout amount determined on the basis of the radio waves received via the antenna 177, and the calculation-based payout amount calculated on the basis of the game result and details of the bet of the corresponding winner totally match each other. Alternatively, the management control device 50 may determine only whether or not the image-based payout amount matches the calculation-based payout amount, or only whether or not the RFID-based payout amount matches the calculation-based payout amount.

In the aforementioned description, the management control device 50 determines the total decrease amount using the RFID again if it is determined that payout for all winners is completed. In addition, the management control device 50 turns on the indicator lamp 174 if the total decrease amount matches the total calculation-based payout amount. Alternatively, the management control device 50 may operate as follows. Specifically, the management control device 50 stores the RFID information read whenever there is a change in the amount of the game tokens 120 in the game token tray 17 as described above. In addition, the management control device 50 may determine the total decrease amount whenever there is a change in the amount of the game tokens 120 in the game token tray 17 and determine whether or not the total decrease amount matches the total calculation-based payout amount. Furthermore, the management control device 50 may turn on the indicator lamp 174 when it is determined that both the amounts match each other.

If the settlement (collection and payout) of the game tokens is completed as described above, the management control device 50 determines whether or not the total change amount of the game tokens in the storing portion 170 through the settlement is correct. Specifically, the management control device 50 obtains a total change amount caused by the settlement (total RFID-based change amount) by calculating a difference between a total amount of the game tokens in the storing portion 170 obtained using the RFID before starting the settlement after completion of the game and a total amount of the game tokens in the storing portion 170 obtained using the RFID after completion of the settlement.

Meanwhile, the management control device 50 calculates the total change amount of the dealer caused by the settlement of the corresponding game on the basis of the game result and details of the bets (total calculation-based change amount). The calculation-based change amount may be obtained by subtracting the total calculation-based payout amount from the calculation-based collection amount. The management control device 50 compares the total RFID-based change amount and the total calculation-based change amount. If both the amounts match each other, the management control device 50 turns on the indicator lamp 174. The dealer can recognize that the settlement of the game tokens in the corresponding game is accurately completed by checking the turn-on state of the indicator lamp 171. Then, the dealer can start the next game.

Next, the indicator lamp 175 will be described. The indicator lamp 175 functions as a pair lamp. In a baccarat game, a player is allowed to bet on “PAIR” in addition to “PLAYER,” “BANKER,” and “TIE.” The “PAIR” means that the first two cards have the same rank. Specifically, the “PAIR” includes “PLAYER PAIR” in which the first two player cards have the same rank and “BANKER PAIR” in which the first two banker cards have the same rank.

In a case where any one of the players is betting on PAIR, and the two cards have the same rank (a pair is established), a predetermined multiplication factor (for example, payment of 11 to 1) of a bet amount of game tokens are paid out for a player who bets the pair regardless of the game result (“PLAYER,” “BANKER,” or “TIE”). If the pair is not established, all of the game tokens bet on the pair are collected. If the pair is not established when the first four cards (two for player and two for banker) are drawn, the game tokens bet on the pair at that timing are collected.

In a case where a bet is made for the “PAIR,” the management control device 50 calculates a total calculation-based collection amount (if the pair is not established) or a total calculation-based payout amount (if the pair established) when the four cards are drawn. In addition, the management control device 50 compares it with the total change amount of the game tokens in the storing portion 170 obtained using the RFID before and after the settlement for the pair. Note that the management control device 50 may recognize whether or not a bet is made on the pair or the bet amount on the basis of the image of the camera device 2.

If the total calculation-based collection amount or the total calculation-based payout amount matches the total change amount of the game tokens in the storing portion 170, the management control device 50 turns on the indicator lamp 175. The dealer can recognize that the settlement for the pair is accurately completed by checking the turn-on state of the indicator lamp 175.

Alternatively, the management control device 50 may turn on the indicator lamp 175 if a bet is made on the pair. The timing for turning on the indicator lamp 175 may be either when the bets conclude or when the four cards are drawn. In this case, the dealer can recognize that it is necessary to perform settlement for the pair by checking the turn-on state of the indicator lamp 175.

In this case, the management control device 50 turns off the indicator lamp 175 if the total calculation-based collection amount or the total calculation-based payout amount matches the total change amount of the game tokens in the storing portion 170. The dealer can recognize that the settlement for the pair is accurately completed by checking the turn-off state of the indicator lamp 175.

Note that, in the baccarat game, a game may conclude by drawing the four cards (two for player cards and two for banker cards), or the fifth card or the subsequent sixth card may be drawn, depending on the ranks of the distributed cards, in some cases. If the game concludes with four draws, the typical settlement described above is performed as soon as the settlement of the pair is finished. If the fifth or subsequent card is drawn, the settlement for the pair is performed after drawing the fourth card. As the settlement for the pair is completed, the fifth card (or the subsequent sixth card) is drawn. As the game concludes, the typical settlement described above is performed.

Note that, in the aforementioned embodiment, during the collection stage, the indicator lamp 176 of the loser whose game tokens are to be collected is turned on, and the indicator lamp 176 is turned off in order of the player for which the collection is completed. Similarly, during the payout stage, the indicator lamp 176 of the winner for which the game tokens are to be paid out is turned on, and the indicator lamp 176 is turned off in order of the player for which the payout is completed. Alternatively, all of the indicator lamps 176 may be turned on by changing color between the winner and the loser at the end of the game.

For example, the indicator lamp 176 corresponding to the loser may be turned on in red, and the indicator lamp 176 corresponding to the winner may be turned on in green. In this case, the dealer can recognize that the collection from all of the losers is accurately completed by checking the turn-off states of all the red indicator lamps 176. In addition, the dealer can recognize that the payout for all the winners is accurately completed by checking the turn-off states of all the green indicator lamps 176.

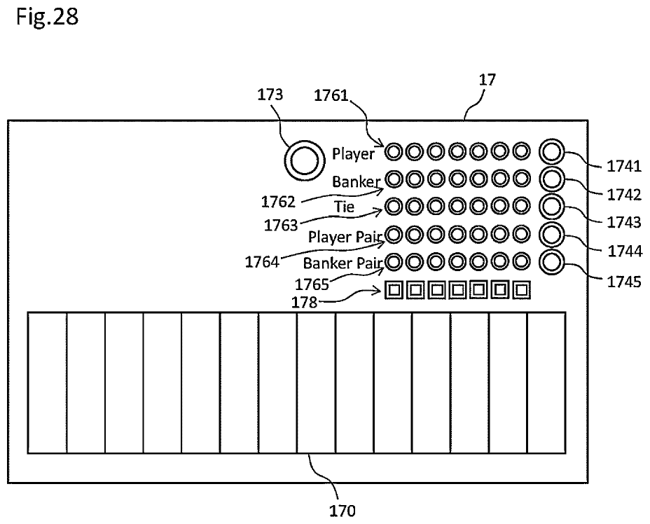

FIG. 28 is a plan view illustrating a game token tray according to a modification. In the game token tray 17 of FIG. 28, like reference numerals denote like elements as in the game token tray 17 of FIG. 26, and they will not be described for simplicity purposes. In the game token tray 17 of this modification, the indicator lamps 1761 to 1765 of each bet target (specifically, the indicator lamp 1761 indicating “PLAYER,” the indicator lamp 1762 indicating “BANKER,” the indicator lamp 1763 indicating “TIE,” the indicator lamp 1764 indicating “PLAYER PAIR,” and the indicator lamp 1765 indicating “BANKER PAIR”) and the indicator lamp 178 indicating that the settlement is accurately completed are provided for each player position.

The indicator lamps 1761 to 1765 are turned on depending on the bet target of each player (position where the game tokens are placed), and are turned off as the settlement is completed. The indicator lamp 178 is turned on when the settlement is accurately completed for each player.

The game token tray 17 according to the first modification has indicator lamps 1741 to 1745 indicating that the settlement for each bet target (such as “PLAYER,” “BANKER” “TIE,” “PLAYER PAIR,” and “BANKER PAIR”) is accurately completed. The game tokens are paid out for any one of “PLAYER,” “BANKER,” and “TIE,” and are collected for the other bets, depending on the game winning/losing result. In addition, if the player pair is established, the game tokens are paid out for “PLAYER PAIR.” If the player pair is not established, the game tokens are collected for “PLAYER PAIR.” Similarly, if the banker pair is established, the game tokens are paid for “BANKER PAIR.” If the banker pair is not established, the game tokens are collected for “BANKER PAIR.” The indicator lamps 1741 to 1745 are turned on when the settlement (collection or payout) for each of “PLAYER,” “BANKER” “TIE,” “PLAYER PAIR,” and “BANKER PAIR” is accurately completed.

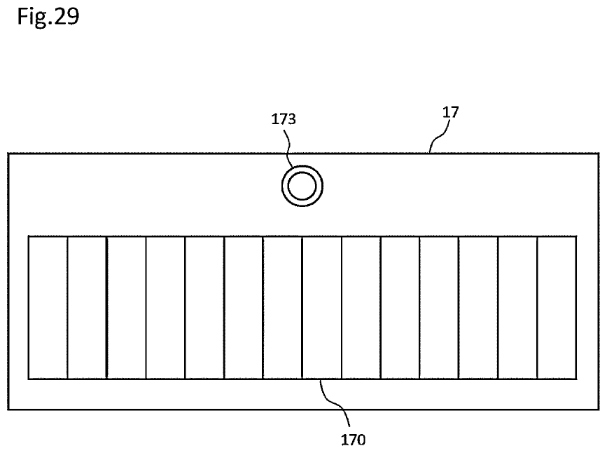

FIG. 29 is a plan view illustrating a game token tray 17 according to another modification. As illustrated in the example of FIG. 29, the game token tray 17 may have only the indicator lamp 173 indicating whether or not the balance between the collected amount and the paid amount is correct.

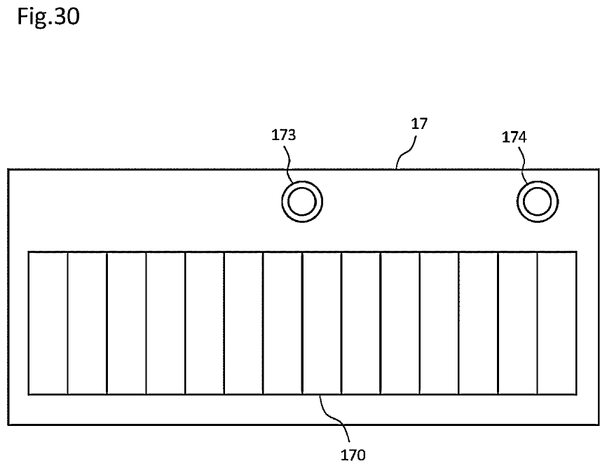

FIG. 30 is a plan view illustrating a game token tray 17 according to further another modification. As illustrated in FIG. 30, the game token tray 17 may have an indicator lamp 173 indicating whether or not the balance between the collected amount and the paid amount is correct and the indicator lamp 174 indicating whether or not a total collected amount is correct and whether or not a total paid amount is correct.

Note that, in the aforementioned embodiment and its modifications, the management control device 50 determines the amount of game tokens stored in the game token tray 17 by wirelessly reading the information from the RFID embedded in the game token using the RFID embedded in the game token and the antenna 177 embedded under the game token tray 17. Alternatively, the management control device 50 may determine the amount of the game tokens stored in the game token tray 17 by providing a camera device for photographing the game tokens stored in the game token tray 17 and recognizing the image of the camera device. In this case, the game token may not have the RFID.

In the aforementioned embodiment, a plurality of indicator lamps including the indicator lamp 173 are physically realized as lamps. Alternatively, such lamps may be provided as images on a display device such as a liquid crystal panel.

In the aforementioned embodiment, the information regarding the type and the number of the game tokens 120 stored in the game token tray 17 is determined by reading the RFID embedded in the game token 120. Alternatively or additionally, the information regarding the type and the number of the game tokens 120 stored in the game token tray 17 may be determined by providing a camera device for photographing the game tokens 120 stored in the game token tray 17 and recognizing the image using the management control device 50. In this case, as the camera device for photographing the game token tray 17, the camera device 2 described above may be commonly used, or a dedicated camera device may be provided.

In a case where image recognition is performed for the image of the camera device in addition to the RFID reading, the game tokens 120 may be verified by comparing the number of the game tokens 120 obtained through the RFID reading with the number of the game tokens determined through the image recognition. If the RFID of the game token tray 17 is failed, or the stored game token has no RFID (wrongful game token), the number determined through the image recognition becomes larger than the number determined through the RFID reading. Therefore, in the case of such discrepancy occurs, the management control device 50 turns on the indicator lamp, so that the dealer can recognize that a wrongful game token is contained in the game token tray 17 by checking the indicator lamp.

In particular, in a case where a discrepancy in the number of the game tokens occurs as a result of performing the RFID reading and the image recognition at a predetermined time interval and performing the aforementioned comparison whenever the information is updated, it is recognized that such a discrepancy is caused by the game token 120 recently added to the game token tray 17. Therefore, it is possible to identify a player who has a wrongful game token.

The management control device 50 may verify that the corresponding game tokens do not exist on the gaming table as the dealer collects the game tokens from the gaming table. In this case, specifically, the management control device 50 determines how much game tokens are bet on which bet target and what is the type of the game tokens on the basis of the image from the camera device 2, determines the amount to be collected in accordance with the game rule according to the game result of the card distribution device 3 (calculation-based collection amount), and verifies that the game tokens 120 corresponding to the calculation-based collection amount do not exist on the gaming table 4 on the basis of the image from the camera device 2.

The management control device 50 may verify whether or not the collection is accurately performed by comparing the amount of the game tokens that do not exist on the gaming table 4 (image-based collection amount) with the amount of the game tokens added to the game token tray 17 on the basis of the image from the camera device 2 described above. In this case, if both the amounts do not match as a result of the comparison, the management control device 50 turns on the indicator lamp.

The management control device 50 may verify that the corresponding game tokens exist on the gaming table as a result that the dealer pays out the game tokens on the gaming table. In this case, specifically, the management control device 50 determines how much game tokens are bet on which bet target and what is the type of the game tokens on the basis of the image from the camera device 2, determines the amount to be paid out in accordance with the game rule according to the game result of the card distribution device 3 (calculation-based payout amount), and verifies that the game tokens 120 corresponding to the calculation-based payout amount are added on the gaming table 4 on the basis of the image from the camera device 2.

The management control device 50 may verify whether or not the payout is accurately performed by comparing the amount of the game tokens added on the gaming table 4 (image-based payout amount) and the amount of the game tokens extracted from the game token tray 17 on the basis of the image from the camera device 2 described above. In this case, if both the amounts do not match as a result of the comparison, the management control device 50 turns on the indicator lamp.

As described above, the dealer basically collects the game tokens 120 bet by the losers in order of the player position number. The management control device 50 determines whether or not the dealer takes the chips in accordance with this rule (in order of the player position number) and also determines whether or not the amount of the chips sequentially collected is correct. In this case, the management control device 50 determines how far the dealer collects the game tokens (what is the player position at which collection of the game tokens is currently performed) in addition to the individual player position and all of the player positions, and accordingly determines whether or not the game tokens 120 collected from the gaming table 4 in each stage are reliably added to the game token tray 17. For example, when the game tokens 120 are collected from three positions, the management control device 50 determines whether or not the game tokens 120 are reliably stored in the game token tray 17 from three positions.

As described above, according to this embodiment and its modifications, the indicator lamp 173 or the like is provided to indicate whether a change of the game tokens in the game token tray 17 after an end of the game is accurate and/or inaccurate. Therefore, it is possible to recognize, in real time, whether or not settlement is accurately performed at the time of the settlement.

While various embodiments of the invention have been described hereinbefore, a person ordinarily skilled in the art would modify them within the scope of the invention. In addition, the devices according to the embodiments may be appropriately modified as necessary depending on an applied game.

A game token according to an aspect of the present invention is a game token in which a stacked structure body formed by a plurality of plastic layers is configured by stacking at least a coloring layer and a white layer or a thin-color layer, a stripe pattern is formed on a side face in a stacking direction, a configuration enabling a type of game token to be specified by the coloring layer is included, a print layer representing a type of the game token is applied to a further upper and lower faces of the stacked structure body, and a layer structure is formed by thermo-compressing each interlayer.

In the game token described above, a side ID that can be individually identified may be attached to an outer face of the white layer or the thin-color layer.

In the game token described above, the side IDs may be attached to at least three or more positions spaced apart in a rotation direction of the side face of the game token.

In the game token described above, the side ID may be printed using ink that is not visible for visible light.

In the game token described above, the side ID may be printed using ink absorbing infrared rays.

In the game token described above, the side ID may be disposed in a plurality of rows on each of outer faces of two layers of the white layers or the thin-color layers.

In the game token described above, R processing may be performed for outer angles of upper and lower faces of the print layer.

In the game token described above, at least one layer of the plurality of plastic layers may be a heavy layer containing metal powder used for increasing the weight.

In the game token described above, the metal powder used for increasing the weight may be a metal oxide and may be one or a plurality of metal oxides, particularly, among a zinc oxide and a titanium oxide.

In the game token described above, white layers or thin-color layers may be disposed on both sides with the coloring layer interposed therebetween, and thicknesses of upper and lower layers of the white layers or the thin-color layers having the coloring layer interposed therebetween may be configured to be different from each other.

In the game token described above, an RFID may be tightly fixed between plastic layers each forming any one of the coloring layer and the white layer or the thin-color layer.

In the game token described above, a face code formed using UV emission ink or ink absorbing infrared rays may be disposed on the print layer.

In the game token described above, a structure in which side IDs are attached to a side face, and an RFID is built may be formed, a face code formed using UV emission ink or ink absorbing infrared rays is disposed on the print layer, and information of the sides ID attached to the side face and information of the RFID may be associated with each other, the information of the side ID and information of the face code may be associated with each other, or the information of the side ID, the information of the RFID, and the information of the face code may be associated with each other.

An inspection device according to an aspect of the present invention is an inspection device inspecting the game token and includes: an RFID reading device that reads information of the RFID of the game token; an ID reading device that reads the side ID disposed on the side face; and a control device. A relation between information of the side ID acquired by the ID reading device and information acquired by the RFID reading device is configured to be inspected.

An inspection device according to another aspect of the present invention is an inspection device inspecting the game token and includes: a face code reading device that reads the face code formed using UV emission ink or ink absorbing infrared rays disposed on the surface of the game token; an ID reading device that reads the side ID disposed on the side face; and a control device. The control device is configured to inspect a relation between information of the side ID acquired by the ID reading device and information acquired by the face code reading device.

An inspection device according to further another aspect of the present invention is an inspection device inspecting the game token and includes: a face code reading device that reads the face code formed using UV emission ink or ink absorbing infrared rays disposed on the surface of the game token; an ID reading device that reads the side ID disposed on the side face; an RFID reading device that reads information of the RFID of the game token; and a control device. A relation among information of the side ID acquired by the ID reading device, information acquired by the face code reading device, and information acquired by the RFID reading device is configured to be inspected.

In the inspection device described above, the side ID may be printed using at least one or a combination of ink that is visible for visible light and ink absorbing infrared rays, and the ID reading device may include one or a plurality of visible-light cameras or infrared-ray cameras corresponding to the ink used for printing the side ID or a camera capable of performing switching among a plurality of functions of a visible-light camera and an infrared-ray camera corresponding to the ink.

In the inspection device described above, a determination device of a type of the game token that images the side face of the game token and determines a color of a stripe pattern of the side face in a stacking direction or a print inspecting device that reads a print of a print layer arranged in the game token may be further included, and a relation between the type of the game token and a print content of the print layer may be inspected.

A method of manufacturing game token according to an aspect of the present invention includes: forming a stacked structure body formed by a plurality of plastic layers by stacking at least a coloring layer and a white layer or a thin-color layer; arranging a print layer in which a drawing pattern is printed on at least an upper face or a lower face of the stacked structure body of the plurality of plastic layers; generating a game token original plate by heating and welding the layers by performing thermo-pressing of the layers of the stacked structure body and the print layer; and acquiring a plurality of game tokens having a predetermined shape by performing punching processing of the game token original plate using a mold and performing R processing of upper and lower angles of outer sides of the game token using a mold at the time of performing the punching processing.

A method of manufacturing game token according to another aspect of the present invention includes: forming a stacked structure body formed by a plurality of plastic layers by including a coloring layer at least in the middle and stacking a white layer or a thin-color layer on upper and lower sides of the coloring layer disposed in the middle; using a layer containing metal powder or a metal oxide used for increasing the weight inside the layer as at least one layer of the plurality of plastic layers; arranging a print layer in which a drawing pattern is printed on at least an upper face or a lower face of the stacked structure body; generating a game token original plate by heating and welding the layers by performing thermo-pressing of the layers of the stacked structure body and the print layer; and acquiring a plurality of game tokens having a predetermined shape by performing punching processing of the game token original plate using a mold.

In the method of manufacturing game token described above, a side ID may be attached through inkjet printing.

In the method of manufacturing game token described above, an RFID may be interposed between the layers of the stacked structure body, and the layers having the RFID interposed therebetween may be heated and welded when the layers are thermos-compressed, and a periphery of the RFID may be tightly fixed by the plastic layers.

In the method of manufacturing game token described above, one or a plurality of face codes, security marks, optical variable devices (OVD) may be printed in the print layer.

A management system of a table game according to an aspect of the present invention includes: a card distributing device that determines and displays a result of winning/losing of each game in a game table; a camera device that images and records game tokens placed on the game table by using a camera; a management control device that specifies and stores a position, types, and quantities of the game tokens placed on the game table by a game participant by using a result of the imaging performed by the camera device in each game. The game token is formed as a structure body including a coloring layer and a white layer or a thin-color layer at least in an outer appearance to form a stripe pattern on a side face in an axial direction and has a configuration enabling the type of the game token to be specified using the coloring layer, and the management control device has a calculation function of calculating a balance of a casino side on the game table for each game by using the result of winning/losing acquired from the card distributing device and the result of the imaging of the position, the types, and the quantities of the game tokens placed by a game participant.

In the management system of a table game described above, the management control device may have a function of determining the types and an amount of the game tokens by using colors of coloring layers by measuring the numbers of the coloring layers or white layers or thin-color layers of the game token placed by each game participant.

In the management system of a table game described above, while the management control device images the position, the types, and the quantities of the game tokens placed by each game participant in each game, it is performed when the card distributing device detects drawing of a first card, before and after the drawing, or after recognition of a dealer's signal representing an end of betting in the management control device.

A management system of a table game according to another aspect of the present invention includes: a game token tray that is disposed on a game table and holds game tokens for each type; a camera device that images the game tokens placed in the game token tray by using a camera; and a management control device that specifies and stores types and quantities of game tokens disposed on the game token tray by using a result of the imaging performed by the camera device. The game token is formed as a structure body including a coloring layer and a white layer or a thin-color layer at least in an outer appearance to form a stripe pattern on a side face in an axial direction and has a configuration enabling the type of the game token to be specified using the coloring layer, and the management control device is configured to be able to measure a total amount of the game tokens disposed on the game token tray by using a result of the imaging of the types and the quantities of the game tokens disposed on the game token tray.

In the management system of a table game described above, the management control device may have a function of determining the types and an amount of the game tokens by using colors of coloring layers by measuring the numbers of the coloring layers or white layers or thin-color layers of game token placed by each game participant.

In the management system of a table game described above, the management control device may be configured to be able to determine a difference of a real total amount of game tokens after end of a game that is perceived in the game token tray of a dealer of the game table that does not correspond to an increased/decreased amount of game tokens calculated based on an amount of game tokens bet by all the players and a result of winning/losing of the game.

In the management system of a table game described above, the acquisition of the total amount of the game tokens in the game token tray through the management device after a settlement at the time of end of a game may be performed at one of: 1) time when re-payment for winning game tokens ends; 2) time when cards used in the game are collected and are disposed in a disposal area of the table; 3) time when a predetermined button accompanying a winning/losing result determining device is pressed; and 4) time when a marker representing winning/losing is returned to the original state.

In the management system of a table game described above, the camera device may also be able to image bills used for exchange of the game tokens, and the management control device may be configured to specify types and quantities of game tokens disposed on the game token tray to be decreased according to exchange of the game tokens disposed on the game token tray and bills by using a result of the imaging of the bills and be able to perform a comparison/measurement with a real total amount of the game tokens disposed on the game token tray.

In the management system of a table game described above, the management control device may determine through a comparison whether a total amount of game tokens perceived in the game token tray of a dealer of a game table corresponds to an increase/decrease according to a paid amount of game tokens corresponding to exchanged bills after the exchange of the bills and game tokens is performed and an increase/decrease in game tokens calculated based on an amount of game tokens bet by all the players and a result of winning/losing of the game.

In the management system of a table game described above, the management control device may have an artificial intelligence-utilizing or deep-learning structure capable of acquiring information of types and quantities of game tokens also in a state in which a part or one unit of the game tokens is hidden due to a blind area of the camera when the types and the quantities of the game tokens are measured and determined.

In the management system of a table game described above, a side ID may be attached to the white layers or the thin-color layers of the side face of the game token at least at three or more positions spaced apart in a rotation direction, types and manufacturing information of game token may be able to be specified by reading the side ID by using the ID reading device, and the specified information specified through measurement may have a configuration that can be collated and managed with a predetermined database.

In the management system of a table game described above, the side ID may be printed using at least one of or both ink that is visible for visible light and ink absorbing infrared rays, and the ID reading device may include one or a plurality of visible-light cameras or infrared-ray cameras corresponding to the ink used for printing the side ID or a camera capable of performing switching among a plurality of functions of a visible-light camera and an infrared-ray camera corresponding to the ink.

In the management system of a table game described above, the camera device imaging and recording game tokens disposed on the game table may be configured to image the game tokens by using one or a plurality of cameras having different heights arranged at predetermined positions.

1. A game token management system comprising:
a plurality of game tokens each having a radio frequency identification (RFID) tag storing an individually unique identifier (ID);
a gaming table for playing a game using the plurality of game tokens;
a game token tray for storing a portion of the plurality of game tokens corresponding to a dealer;
a first measurement device configured to measure a position, a type, and number of game tokens on the gaming table based at least in part on the RFID tags of each game token on the gaming table;
a game status determination device configured to determine a start of the game and an end of the game; and
a management control device configured to:
recognize an amount of game tokens for each player position on the gaming table at the start of the game and the end of the game using a measurement result obtained from the first measurement device;
compare the amount of game tokens for each player position at the start of the game and the end of the game; and
determine whether there is an increase or decrease of the amount based on comparing the amount of game tokens for each player position at the start of the game and the end of the game.

2. The game token management system according to claim 1, further comprising:
a second measuring device configured to measure types and a number of the portion of the plurality of game tokens stored in the game token tray,
wherein the management control device is further configured to determine whether there is an increase or decrease of the types and the number of the portion of the plurality of game tokens stored in the game token tray based on a comparison of the types and the number of the game tokens measured by the second measurement device at the start of the game and the end of the game.

3. The game token management system according to claim 1, wherein the game status determination device is a card distribution device configured to:
accommodate playing cards to be distributed to the gaming table during the game,
detect the playing cards distributed to the gaming table, and
determine the start and end of the game based on results of the detections of the playing cards.

4. The game token management system according to claim 3, further comprising:
a second measuring device configured to measure types and a number of the portion of the plurality of game tokens stored in the game token tray,
wherein the management control device is further configured to determine whether there is an increase or decrease of the types and the number of the portion of the plurality of game tokens stored in the game token tray based on a comparison of the types and the number of the game tokens measured by the second measurement device at the start of the game and the end of the game.

5. The game token management system according to claim 4, wherein the control device is configured to compare an amount of the portion of the plurality of game tokens stored in the game token tray measured by the second measurement device before an exchange of game tokens for the other type of game tokens and an amount of the portion of the plurality of game tokens stored in the game token tray measured by the second measurement device after the exchange of game tokens.

6. The game token management system according to claim 4, wherein the control device is configured to acquire an amount of bills paid by a player for an exchange for the game tokens, and
the control device is configured to compare the amount of bills and a difference between an amount of the portion of the plurality of game token stored in the game token tray measured by the second measurement device before the exchange and an amount of the portion of the plurality of game token stored in the game token tray measured by the second measurement device after the exchange.

7. The game token management system according to claim 1, wherein the game status determination device comprises:
a camera configured to capture images of playing cards used in the game played at the gaming table; and
an image analyzing device configured to:
analyze the images to determine a progress of the game; and
determine the start of the game and the end of the game based on the determined progress of the game.

8. The game token management system according to claim 7, further comprising a second measuring device configured to measure types and a number of the portion of the plurality of game tokens stored in the game token tray,
wherein the management control device is further configured to determine whether there is an increase or decrease of the types and the number of the portion of the plurality of game tokens stored in the game token tray based on a comparison of the types and the number of the game tokens measured by the second measurement device at the start of the game and the end of the game.

9. The game token management system according to claim 8, wherein the first measurement device comprises:
a camera configured to capture an image of the game tokens used on the gaming table; and
an image analyzing device configured to analyze the image to measure the position, the type, and the number of the game tokens used on the gaming table.

10. The game token management system according to claim 8, wherein the first measurement device includes:
a first camera configured to capture a first image of the game tokens on the gaming table; and
a first image analysis device configured to analyze the first image to measure the position, the type, and the number of the game tokens on the gaming table, and
the second measurement device includes:
a second camera configured to capture a second image of the portion of the plurality of game tokens stored in the game token tray; and
a second image analysis device configured to analyze the second image to measure the type and the number of the game tokens in the portion of the plurality of game tokens stored in the game token tray.

11. The game token management system according to claim 8, wherein the first measurement device is a first RFID reader configured to read the RFID tags of the game tokens on the gaming table to measure the position, the type, and the number of the game token on the gaming table, and
the second measurement device is a second RFID reader configured to read the RFID tags of the portion of the plurality of game tokens stored in the game token tray to measure the type and the number of the portion of the plurality of game tokens stored in the game token tray.

12. The game token management system according to claim 1, wherein the first measurement device is further configured to measure a type and the number of one or more game tokens carried from a cage to the gaming table to fill the game token tray.

13. The game token management system according to claim 1, wherein the first measurement device is further configured to measure a type and a number of one or more game tokens to be carried to a cage to credit the game token tray.

14. The game token management system according to claim 1, wherein the first measurement device is further configured to measure a type and a number of first game tokens a type and a number of second game tokens, wherein the first game tokens are exchanged for the second game tokens, and
the control device is configured to compare an amount of the first game tokens measured by the first measurement device and an amount of the second game tokens measured by the first measurement device.

15. The game token management system according to claim 1, wherein the control device is configured to acquire an amount of bills paid by a player for an exchange for the game tokens,
the first measurement device is further configured to measure a type and number game tokens paid out onto the gaming table by the dealer from the game token tray for the exchange, and
the control device is configured to compare the amount of bills and an amount of the game tokens paid out onto the gaming table by the dealer from the game token tray for the exchange.
